(19) United States
(12) Patent Application Publication
(10) Pub. No.: US 2026/0190154 A1
(43) Pub. Date: Jul. 2, 2026

(54) METHOD AND DEVICE FOR PROCESSING DATA

(71) Applicant: KT CORPORATION, Gyeonggi-do (KR)

(72) Inventor: Sung-pyo HONG, Gyeonggi-do (KR)

(73) Assignee: KT CORPORATION, Gyeonggi-do (KR)

(21) Appl. No.: 19/439,248

(22) Filed: Jan. 2, 2026

(30) Foreign Application Priority Data
Jan. 2, 2025 (KR) 10-2025-0000556
Sep. 9, 2025 (KR) 10-2025-0128644
Dec. 18, 2025 (KR) 10-2025-0203368

(51) Int. Cl. H04W 74/0833; H04W 4/70

(52) U.S. Cl. CPC H04W 74/0833; H04W 4/70

(57) ABSTRACT

Provided are a method and device for processing data in a wireless communication system. The device transmits a first device to reader (D2R) medium access control (MAC) protocol data unit (PDU) including D2R upper layer data. In addition, after transmitting the first D2R MAC PDU, the device receives a first reader to device (R2D) MAC PDU including segment information. Thereafter, the device transmits a second D2R MAC PDU including a D2R upper layer data segment generated according to the segment information.

### CROSS-REFERENCE TO RELATED THE APPLICATION

This application is based on and claims priority under 35 U.S.C. § 119 to Patent Application No. 10-2025-0000556 filed on Jan. 2, 2025, No. 10-2025-0128644 filed on Sep. 9, 2025 and No. 10-2025-0203368 filed on Dec. 18, 2025 in the Korean Intellectual Property Office, the disclosures of which are incorporated by reference herein in their entirety.

### BACKGROUND

### Technical Field

The present disclosure relates to wireless communication applicable to 5G NR, 5G-Advanced and 6G.

### Description of the Related Art

With the increase in the number of communication devices, there is a consequent rise in communication traffic that needs to be managed. To handle this increased communication traffic, a next generation 5G system, which is an enhanced mobile broadband communication system compared to the existing LTE system, has become necessary. Such a next generation 5G system has been developed based on scenarios classified as Enhanced Mobile BroadBand (eMBB), Ultra-reliable and low-latency communication (URLLC), Massive Machine-Type Communications (mMTC), and the like.

eMBB, URLLC, and mMTC represent next generation mobile communication scenarios. eMBB is characterized by high spectral efficiency, high user experienced data rate, high peak data. URLLC is characterized by ultra-reliability, ultra-low latency, ultra-high availability (e.g., vehicle-to-everything (V2X), Emergency Service, Remote Control). mMTC is characterized by low cost, low energy consumption, short packet transmission, and massive connectivity (e.g., Internet of Things (IoT)).

### SUMMARY

The disclosure provides a method and device for data processing by a device that offers ultra-low complexity and ultra-low power operation in a wireless communication system.

According to an embodiment, a method of a device may be provided for processing data in a wireless communication system. The method of the device may include transmitting a first device to reader (D2R) medium access control (MAC) protocol data unit (PDU) including D2R upper layer data, after transmitting the first D2R MAC PDU, receiving a first reader to device (R2D) MAC PDU including segment information, and transmitting a second D2R MAC PDU including a D2R upper layer data segment generated according to the segment information.

According to another embodiment, a device may be provided for processing data in a wireless communication system. The terminal may include at least one processor; and at least one memory configured to store instructions and operably electrically connectable to the at least one processor, wherein operations performed based on the instructions executed by the at least one processor include: transmitting a first device to reader (D2R) medium access control (MAC) protocol data unit (PDU) including D2R upper layer data, after transmitting the first D2R MAC PDU, receiving a first reader to device (R2D) MAC PDU including segment information, and transmitting a second D2R MAC PDU including a D2R upper layer data segment generated according to the segment information.

The device may receive a response message for contention-based random access, and the first D2R MAC PDU may be transmitted after receiving the response message.

Alternatively, the device may receive a paging message, and the first D2R MAC PDU may be transmitted after receiving the paging message. In this case, the paging message may include information indicating contention-free access.

Alternatively, the device may receive a second R2D MAC PDU, and the first D2R MAC PDU may be transmitted after receiving the second R2D MAC PDU.

Meanwhile, the segment information may be a data size indicating the last byte of original D2R upper layer data received by a reader. In this case, the D2R upper layer data segment may be generated starting from a byte immediately following the data size.

The first R2D MAC PDU may further include information indicating whether R2D upper layer data is included.

### BRIEF DESCRIPTION OF THE DRAWINGS

FIG. 1 is a diagram illustrating a wireless communication system.

FIG. 2 is a diagram illustrating a structure of a radio frame used in new radio (NR).

FIGS. 3A to 3C illustrate exemplary architectures for a wireless communication service.

FIG. 4 illustrates a slot structure of an NR frame.

FIG. 5 shows an example of a subframe type in NR.

FIG. 6 illustrates a structure of a self-contained slot.

FIGS. 7A to 7B illustrate examples of connectivity topologies for an ambient IoT network and a device.

FIG. 8 illustrates an example of a procedure for an A-IoT inventory service.

FIG. 9 illustrates an example of an access stratum (AS) procedure between an A-IoT device and a reader.

FIGS. 10A to 10B illustrate A-IoT access procedures to which one embodiment of the present specification may be applied.

FIG. 11 is a block diagram showing apparatuses according to an embodiment of the disclosure.

FIG. 12 is a block diagram showing a terminal according to an embodiment of the disclosure.

FIG. 13 is a block diagram of a processor in accordance with an embodiment.

FIG. 14 is a detailed block diagram of a transceiver of a first apparatus shown in FIG. 11 or a transceiving unit of an apparatus shown in FIG. 12.

### DETAILED DESCRIPTION

The technical terms used in this document are for merely describing specific embodiments and should not be considered limiting the embodiments of disclosure. Unless defined otherwise, the technical terms used in this document should be interpreted as commonly understood by those skilled in the art but not too broadly or too narrowly. If any technical terms used here do not precisely convey the intended meaning of the disclosure, they should be replaced with or interpreted as technical terms that accurately understood by those skilled in the art. The general terms used in this document should be interpreted according to their dictionary definitions, without overly narrow interpretations.

The singular form used in the disclosure includes the plural unless the context dictates otherwise. The term ‘include’ or ‘have’ may represent the presence of features, numbers, steps, operations, components, parts or the combination thereof described in the disclosure. The term ‘include’ or ‘have’ may not exclude the presence or addition of another feature, another number, another step, another operation, another component, another part or the combination thereof.

The terms ‘first’ and ‘second’ are used to describe various components without limiting them to these specific terms. The terms ‘first’ and ‘second’ are only used to distinguish one component from another component. For example, a first component may be named as a second component without departing from the scope of the disclosure.

When an element or layer is referred to as being “connected to” or “coupled to” another element or layer, it may be directly connected or coupled to the other element or layer, there might be intervening elements or layers. In contrast, when an element or layer is referred to as being “directly connected to” or “directly coupled to” another element or layer, there are no intervening elements or layers.

Hereinafter, the exemplary embodiments of the disclosure will be described in detail with reference to the accompanying drawings. In describing the disclosure, for ease of understanding, the same reference numerals will be used throughout the drawings for the same components, and repetitive description on these components will be omitted. Detailed description on well-known arts that may obscure the essence of the disclosure will be omitted. The accompanying drawings are provided to merely facilitate understanding of the embodiment of disclosure and should not be seen as limiting. It should be recognized that the essence of this disclosure extends the illustrations, encompassing, replacements or equivalents in variations of what is shown in the drawings.

In this disclosure, “A or B” may mean “only A”, “only B”, or “both A and B”. In other words, “A or B” in the disclosure may be interpreted as “A and/or B”. For example, “A, B or C” may mean “only A”, “only B”, “only C”, or “any combination of A, B and C”.

In this disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In this disclosure, “at least one of A and B” may mean “only A”, “only B” or “both A and B”. In addition, “at least one of A or B” or “at least one of A and/or B” may be interpreted as the same as “at least one of A and B”.

In addition, “at least one of A, B and C” may mean “only A”, “only B”, “only C”, or “any combination of A, B and C”. Further, “at least one of A, B or C” or “at least one of A, B and/or C” may mean “at least one of A, B and C”.

Also, parentheses used in this disclosure may mean “for example”. For example, “control information (PDCCH)” may mean that “PDCCH” is an example of “control information”. However, “control information” in this disclosure is not limited to “PDCCH”. As another example, “control information (i.e., PDCCH)”, may also mean that “PDCCH” is an example of “control information”.

Each of the technical features described in one drawing in this disclosure may be implemented independently or simultaneously.

In the accompanying drawings, user equipment (UE) is illustrated as an example and may be referred to as a terminal, mobile equipment (ME), and the like. UE may be a portable device such as a laptop computer, a mobile phone, a personal digital assistance (PDA), a smart phone, a multimedia device, or the like. UE may be a non-portable device such as a personal computer (PC) or a vehicle-mounted device.

Hereinafter, the UE may be as an example of a device capable of wireless communication. The UE may be referred to as a wireless communication device, a wireless device, or a wireless apparatus. The operation performed by the UE may be applicable to any device capable of wireless communication. A device capable of wireless communication may also be referred to as a radio communication device, a wireless device, or a wireless apparatus.

A base station generally refers to a fixed station that communicates with a wireless device. The base station may include an evolved-NodeB (eNodeB), an evolved-NodeB (eNB), a BTS (Base Transceiver System), an access point (Access Point), gNB (Next generation NodeB), RRH (remote radio head), TP (transmission point), RP (reception point), and the repeater (relay).

While embodiments of the disclosure are described based on an long term evolution (LTE) system, an LTE-advanced (LTE-A) system, and an new radio (NR) system, such embodiments may be applicable to any communication system that fits the described criteria.

### <Wireless Communication System>

With the success of long-term evolution (LTE)/LTE-A (LTE-Advanced) for the 4th generation mobile communication, the next generation mobile communication (e.g., 5th generation: also known as 5G mobile communication) has been commercialized and the follow-up studies are also ongoing.

The 5th generation mobile communications, as defined by the International Telecommunication Union (ITU), provide a data transmission rate of up to 20 Gbps and a minimum actual transmission rate of at least 100 Mbps anywhere. The official name of the 5th generation mobile telecommunications is ‘IMT-2020’.

ITU proposes three usage scenarios: enhanced Mobile Broadband (eMBB), massive Machine Type Communication (mMTC) and Ultra Reliable and Low Latency Communications (URLLC).

URLLC is a usage scenario requiring high reliability and low latency. For example, services such as automatic driving, factory automation, augmented reality require high reliability and low latency (e.g., a delay time of less than 1 ms). The delay time of current 4G (e.g., LTE) is statistically about 21 to 43 ms (best 10%) and about 33 to 75 ms (median), which insufficient to support services requiring a delay time of about 1 ms or less. Meanwhile, eMBB is a usage scenario that requires mobile ultra-wideband.

That is, the 5G mobile communication system offers a higher capacity compared to current 4G LTE. The 5G mobile communication system may be designed to increase the density of mobile broadband users and support device to device (D2D), high stability, and machine type communication (MTC). 5G research and development focus on achieving lower latency times and lower battery consumption compared to 4G mobile communication systems, enhancing the implementation of the Internet of things (IoTs). A new radio access technology, known as new RAT or NR, may be introduced for such 5G mobile communication.

An NR frequency band is defined to include two frequency ranges FR1 and FR2. Table 1 below shows an example of the two frequency ranges FR1 and FR2. However, the numerical values associated with each frequency range may be subject to change, and the embodiments are not limited thereto. For convenience of description, FR1 in the NR system may refer to a Sub-6 GHz range, and FR2 may refer to an above-6 GHz range, which may be called millimeter waves (mmWs).

TABLE 1

| Frequency Range | Corresponding frequency | Subcarrier | |
|---|---|---|---|
| designation | range | Spacing | |
| FR1 | 410 MHz-7125 MHz | 15, 30, 60 | kHz |
| FR2 | 24250 MHz-52600 MHz | 60, 120, 240 | kHz |

The numerical values of the frequency ranges may be subject to change in the NR system. For example, FR1 may range from about 410 MHz to 7125 MHz as listed in [Table 1]. That is, FR1 may include a frequency band of 6 GHz (or 5850, 5900, and 5925 MHz) or higher. For example, the frequency band of 6 GHz (or 5850, 5900, and 5925 MHz) or higher may include an unlicensed band. The unlicensed band may be used for various purposes, for example, vehicle communication (e.g., autonomous driving).

The 3GPP communication standards define downlink (DL) physical channels and DL physical signals. DL physical channels are related to resource elements (REs) that convey information from a higher layer while DL physical signals, used in the physical layer, correspond to REs that do not carry information from a higher layer. For example, DL physical channels include physical downlink shared channel (PDSCH), physical broadcast channel (PBCH), physical multicast channel (PMCH), physical control format indicator channel (PCFICH), physical downlink control channel (PDCCH), and physical hybrid ARQ indicator channel (PHICH). DL physical signals include reference signals (RSs) and synchronization signals (SSs). A reference signal (RS) is also known as a pilot signal and has a predefined special waveform known to both a gNode B (gNB) and a UE. For example, DL RSs include cell specific RS, UE-specific RS (UE-RS), positioning RS (PRS), and channel state information RS (CSI-RS). The 3GPP LTE/LTE-A standards also define uplink (UL) physical channels and UL physical signals. UL channels correspond to REs with information from a higher layer. UL physical signals are used in the physical layer and correspond to REs which do not carry information from a higher layer. For example, UL physical channels include physical uplink shared channel (PUSCH), physical uplink control channel (PUCCH), and physical random access channel (PRACH). UL physical signals include a demodulation reference signal (DMRS) for a UL control/data signal, and a sounding reference signal (SRS) used for UL channel measurement.

In this disclosure, PDCCH/PCFICH/PHICH/PDSCH refers to a set of time-frequency resources or a set of REs carrying downlink control information (DCI)/a control format indicator (CFI)/a DL acknowledgement/negative acknowledgement (ACK/NACK)/DL data. Further, PUCCH/PUSCH/PRACH refers to a set of time-frequency resources or a set of REs carrying UL control information (UCI)/UL data/a random access signal.

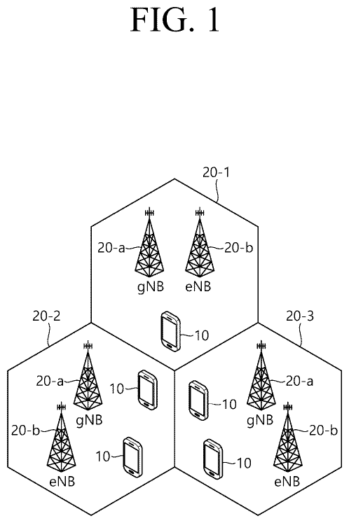

FIG. 1 is a diagram illustrating a wireless communication system.

Referring to FIG. 1, the wireless communication system may include at least one base station (BS). For example, the BSs may include a gNodeB (or gNB) 20a and an eNodeB (or eNB) 20b. The gNB 20a supports 5G mobile communication. The eNB 20b supports 4G mobile communication, that is, long term evolution (LTE).

Each BS 20a and 20b provides a communication service for a specific geographic area (commonly referred to as a cell) (20-1, 20-2, 20-3). The cell may also be divided into a plurality of areas (referred to as sectors).

A user equipment (UE) typically belongs to one cell, and the cell to which the UE belongs is called a serving cell. Abase station providing a communication service to a serving cell is referred to as a serving base station (serving BS). Since the wireless communication system is a cellular system, there are other cells adjacent to the serving cell. The other cell adjacent to the serving cell is referred to as a neighbor cell. A base station that provides a communication service to a neighboring cell is referred to as a neighbor BS. The serving cell and the neighboring cell are relatively determined based on the UE.

Hereinafter, downlink means communication from the base station 20 to the UE 10, and uplink means communication from the UE 10 to the base station 20. In the downlink, a transmitter may be a part of the base station 20, and a receiver may be a part of the UE 10. In the uplink, the transmitter may be a part of the UE 10, and the receiver may be a part of the base station 20.

In a wireless communication system, there are primarily two schemes: frequency division duplex (FDD) scheme and time division duplex (TDD) scheme. In the FDD scheme, uplink transmission and downlink transmission occur on different frequency bands. Conversely, the TDD scheme allows both uplink transmission and downlink transmission to use the same frequency band, but at different times. A key characteristic of the TDD scheme is the substantial reciprocity of the channel response, meaning that the downlink channel response and the uplink channel response are almost identical within a given frequency domain. This reciprocity in TDD-based radio communication systems enables the estimation of the downlink channel response from the uplink channel response. In the TDD scheme, since uplink transmission and downlink transmission are time-divided in the entire frequency band, it is not possible to simultaneously perform downlink transmission by the base station and uplink transmission by the UE. In a TDD system where uplink transmission and downlink transmission are divided into subframe units, uplink transmission and downlink transmission are performed in different subframes.

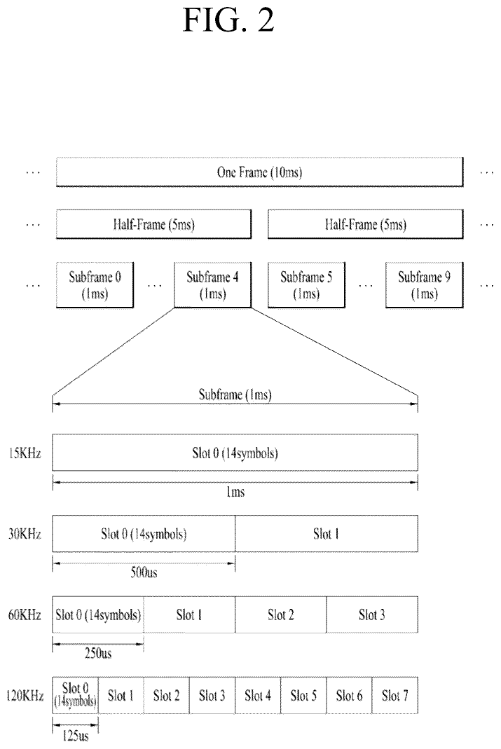

FIG. 2 is a diagram illustrating a structure of a radio frame used in new radio (NR).

In NR, UL and DL transmissions are configured in frames. Each radio frame has a length of 10 ms and is divided into two 5-ms half frames (HFs). Each half frame is divided into five 1-ms subframes. A subframe is divided into one or more slots, and the number of slots in a subframe depends on the subcarrier spacing (SCS). Each slot includes 12 or 14 OFDM(A) symbols according to a Cyclic Prefix (CP). With a normal CP, a slot includes 14 OFDM symbols. With an extended CP, a slot includes 12 OFDM symbols. A symbol may include an OFDM symbol (CP-OFDM symbol) and an SC-FDMA symbol (or DFT-s-OFDM symbol).

### <Support of Various Numerologies>

As wireless communication technology advances, the NR system may offer various numerologies to terminals. For example, when a subcarrier spacing (SCS) is set at 15 kHz, it supports a broad range of the typical cellular bands. When a subcarrier spacing (SCS) is set at 30 kHz/60 kHz, it supports a dense-urban, lower latency, wider carrier bandwidth. When the SCS is 60 kHz or higher, it supports a bandwidth greater than 24.25 GHz in order to overcome phase noise.

These numerologies may be defined by the cyclic prefix (CP) length and the SCS. A single cell in the NR system is capable of providing multiple numerologies to terminals. Table 2 below shows the relationship between the subcarrier spacing, corresponding CP length, and the index of a numerology (represented by μ).

TABLE 2

| μ | Δf = 2^{μ} · 15 [kHz] | CP |
|---|---|---|
| 0 | 15 | normal |
| 1 | 30 | normal |
| 2 | 60 | normal, extended |
| 3 | 120 | normal |
| 4 | 240 | normal |
| 5 | 480 | normal |
| 6 | 960 | normal |

Table 3 below shows the number of OFDM symbols per slot (N^{slot}_{symb}), the number of slots per frame (N^{frame,μ}ₛₗₒₜ), and the number of slots per subframe (N^{subframe,μ}ₛₗₒₜ) according to each numerology expressed by μ in the case of a normal CR.

TABLE 3

| μ | Δf = 2^{μ} · 15 [kHz] | N^{slot}_{symb} | N^{frame, μ}ₛₗₒₜ | N^{subframe, μ}ₛₗₒₜ |
|---|---|---|---|---|
| 0 | 15 | 14 | 10 | 1 |
| 1 | 30 | 14 | 20 | 2 |
| 2 | 60 | 14 | 40 | 4 |
| 3 | 120 | 14 | 80 | 8 |
| 4 | 240 | 14 | 160 | 16 |
| 5 | 480 | 14 | 320 | 32 |
| 6 | 960 | 14 | 640 | 64 |

Table 4 below shows the number of OFDM symbols per slot (N^{slot}_{symb}), the number of slots per frame (N^{frame,μ}ₛₗₒₜ), and the number of slots per subframe (N^{subframe,μ}ₛₗₒₜ) of a numerology represented by t in the case of an extended CR.

TABLE 4

| μ | SCS (15*2^{u}) | N^{slot}_{symb} | N^{frame, μ}ₛₗₒₜ | N^{subframe, μ}ₛₗₒₜ |
|---|---|---|---|---|
| 2 | 60 KHz (u = 2) | 12 | 40 | 4 |

In the NR system, OFDM(A) numerologies (e.g., SCS, CP length, and so on) may be configured differently across multiple cells that are integrated with a single terminal. Accordingly, the duration of time resource may vary among these integrated cells. Here, the duration may be referred to as a section. The time resource may include a subframe, a slot or a transmission time interval (TTI). Further, the time resource may be collectively referred to as a time unit (TU) for simplicity and include the same number of symbols.

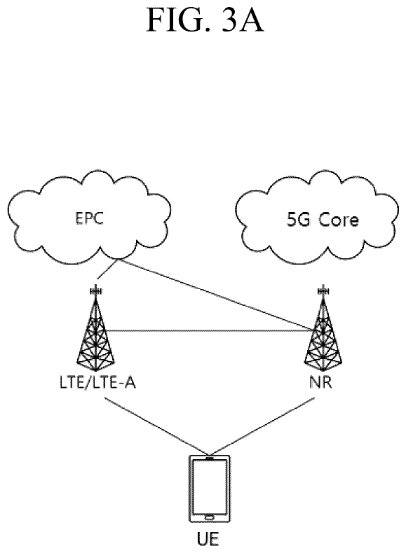

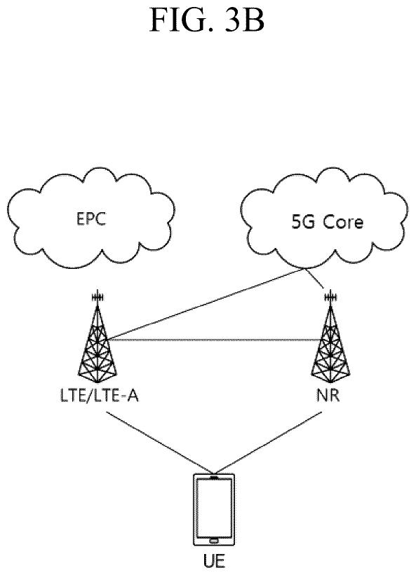

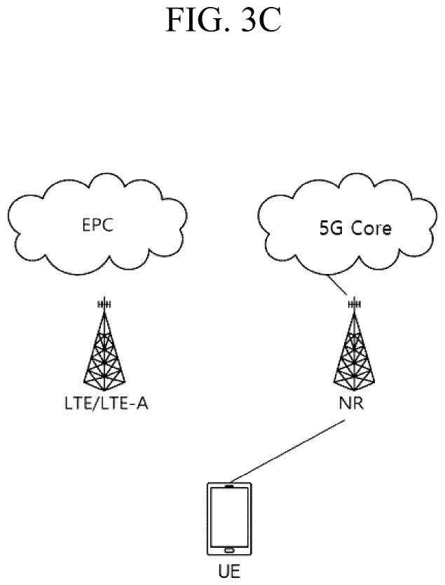

FIGS. 3A to 3C illustrate exemplary architectures for a wireless communication service.

Referring to FIG. 3A, a UE is connected in dual connectivity (DC) with an LTE/LTE-A cell and a NR cell.

The NR cell is connected with a core network for the legacy fourth-generation mobile communication, that is, Evolved Packet core (EPC).

Referring to FIG. 3B, the LTE/LTE-A cell is connected with a core network for 5th generation mobile communication, that is, a 5G core network.

A service provided by the architecture shown in FIGS. 3A and 3B is referred to as a non-standalone (NSA) service.

Referring to FIG. 3C, a UE is connected only with an NR cell. A service provided by this architecture is referred to as a standalone (SA) service.

In the new radio access technology (NR), the use of a downlink subframe for reception from a base station and an uplink subframe for transmission to the base station may be employed. This method may be applicable to both paired spectrums and unpaired spectrums. Paired spectrums involve two subcarriers designated for downlink and uplink operations. For example, one subcarrier within a pair of spectrums may include a pair of a downlink band and an uplink band.

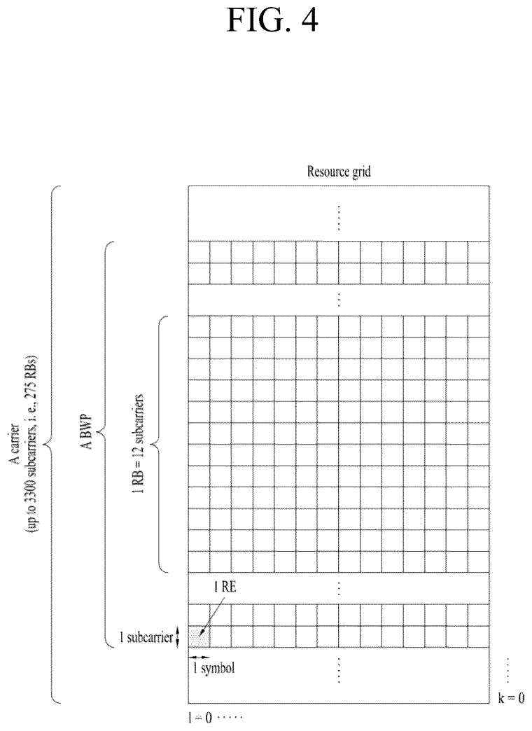

FIG. 4 illustrates a slot structure of an NR frame.

A slot in the NR system includes a plurality of symbols in the time domain. For example, in the case of the normal CP, one slot includes seven symbols. On the other hand, in the case of the extended CP, one slot includes six symbols. A carrier includes a plurality of subcarriers in the frequency domain. A resource block (RB) is defined as a set of consecutive subcarriers (e.g., 12 consecutive subcarriers) in the frequency domain. A bandwidth part (BWP) is defined as a sequence of consecutive physical resource blocks (PRBs) in the frequency domain and may be associated with a specific numerology (e.g., SCS, CP length, etc.). A terminal may be configured with up to N (e.g., five) BWPs in each of downlink and uplink. Downlink or uplink transmission is performed through an activated BWP. Among the BWPs configured for the terminal, only one BWP may be activated at a given time. In the resource grid, each element is referred to as a resource element (RE), and one complex symbol may be mapped thereto.

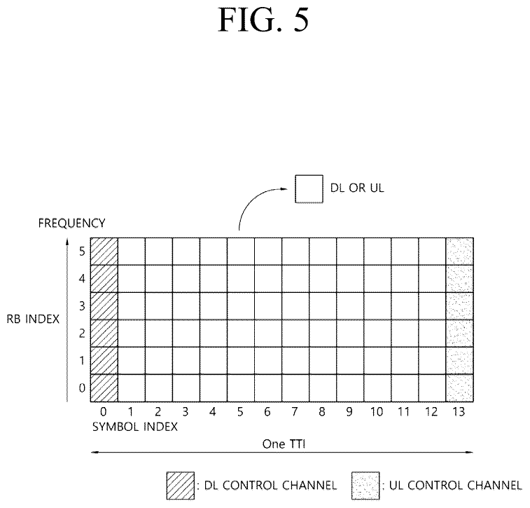

FIG. 5 shows an example of a subframe type in NR.

In NR (or new RAT), a Transmission Time Interval (TTI), as shown in FIG. 5, may be referred to as a subframe or slot. The subframe (or slot) may be utilized in a TDD system to minimize data transmission delay. As shown in FIG. 5, a subframe (or slot) includes 14 symbols. The symbol at the head of the subframe (or slot) may be allocated for a DL control channel, and the symbol at the end of the subframe (or slot) may be assigned for a UL control channel. The remaining symbols may be used for either DL data transmission or UL data transmission. This subframe (or slot) structure allows sequential downlink and uplink transmissions in one single subframe (or slot). Accordingly, downlink data may be received in a subframe (or slot) and uplink ACK/NACK may be transmitted in the same subframe (or slot).

Such a subframe (or slot) structure may be referred to as a self-contained subframe (or slot).

The first N symbols in a slot may be used to transmit a DL control channel and referred to as a DL control region, hereinafter. The last M symbols in the slot may be used to transmit a UL control channel and referred to as a UL control region. N and M are integers greater than 0. A resource region between the DL control region and the UL control region may be used for either DL data transmission or UL data transmission and referred to as a data region. For example, a physical downlink control channel (PDCCH) may be transmitted in the DL control region, and a physical downlink shared channel (PDSCH) may be transmitted in the DL data region. A physical uplink control channel (PUCCH) may be transmitted in the UL control region, and a physical uplink shared channel (PUSCH) may be transmitted in the UL data region.

Using this subframe (or slot) structure reduces the time required for retransmitting data that has failed in reception, thereby minimizing overall data transmission latency. In such a self-contained subframe (or slot) structure, a time gap may be required for transitioning between a transmission mode and a reception mode or from the reception mode to the transmission mode. To accommodate this, a few OFDM symbols when switch from DL to UL in the subframe structure may be configured to a guard period (GP).

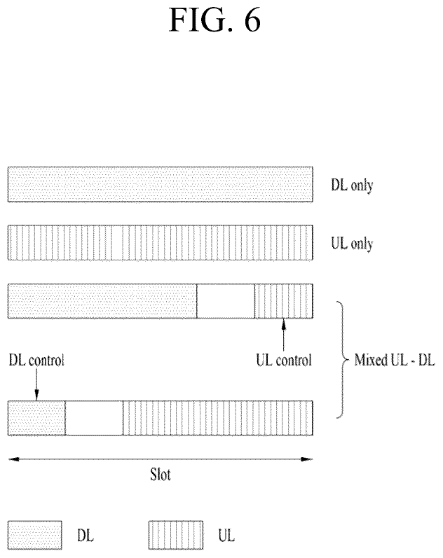

FIG. 6 illustrates a structure of a self-contained slot.

In the NR system, the frames are structured as a self-contained structure, where one single slot includes a DL control channel, either a DL or UL data channel, and UL control channel. For example, the first N symbols in a slot may be used for transmitting a DL control channel and referred to as a DL control region. The last M symbols in the slot may be used for transmitting an UL control channel and referred to as a UL control region. N and M are integers greater than 0. A resource region between the DL control region and the UL control region may be used for either DL data transmission or UL data transmission and referred to as a data region.

For example, the following configurations may be considered. The durations are listed in temporal order.
1. DL only configuration
2. UL only configuration
3. Mixed UL-DL configuration
   −DL region+Guard Period (GP)+UL control region
   −DL control region+GP+UL region
DL region: (i) DL data region, (ii) DL control region+DL data region
UL region: (i) UL data region, (ii) UL data region+UL control region

A physical downlink control channel (PDCCH) may be transmitted in the DL control region, and a physical downlink shared channel (PDSCH) may be transmitted in the DL data region. A physical uplink control channel (PUCCH) may be transmitted in the UL control region, and a physical uplink shared channel (PUSCH) may be transmitted in the UL data region. Through the PDCCH, Downlink Control Information (DCI), for example, DL data scheduling information or UL data scheduling data may be transmitted. Through the PUCCH, Uplink Control Information (UCI), for example, ACK/NACK (Positive Acknowledgement/Negative Acknowledgement) information with respect to DL data, Channel State Information (CSI) information, or Scheduling Request (SR) may be transmitted. A guard period (GP) provides a time gap during a process where a gNB and a UE transition from the transmission mode to the reception mode or a process where the gNB and UE transition from the reception mode to the transmission mode. Some symbols within a subframe that transition from DL to UL mode may be configured as the GP.

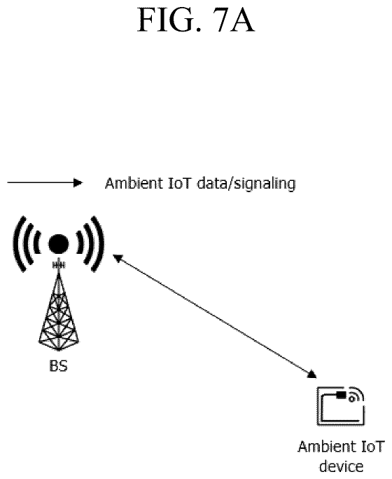

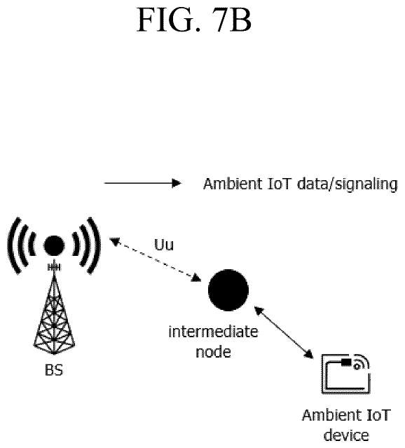

FIGS. 7A to 7B illustrate examples of connectivity topologies for an ambient IoT network and a device.

An ambient Internet of Things (ambient Internet of Things or ambient power-enabled Internet of Things: A-IoT/AIoT) device is an IoT device powered by energy harvesting and having no battery or having limited energy storage capability (for example, using a capacitor). For convenience of description, an AIoT device may hereinafter be referred to as a device. This is merely for convenience of description, and the name may be changed to any other term.

Energy is provided through energy harvesting from radio waves, light, motion, heat, or other suitable power sources. Energy harvesting may be continuous (for example, by vibration) or may occur intermittently. Accordingly, it cannot be assumed that an AIoT device always has power available for data transmission and reception.

An AIoT device needs to be designed to have lower complexity, smaller size, reduced capability, and lower power consumption than previously defined 3GPP IoT terminals/devices (for example, NB-IoT (Narrowband Internet of Things) or eMTC (enhanced Machine Type Communication) devices). An AIoT device may be designed to have a lifetime of more than 10 years without maintenance. Accordingly, AIoT devices may replace existing 3GPP IoT devices or support various use cases (for example, inventory, sensors, positioning, and commands) that cannot be supported by existing 3GPP IoT devices.

Functions and procedures for supporting ambient IoT use cases may be defined as AIoT services (for example, an inventory service and a command service). For example, a main purpose of the inventory service is to search for goods (for example, boxes, containers, packages, or tools) present in a specific area. When a request is transmitted within a network for a specific area, AIoT devices attached to such goods report identifiers associated with the goods, and additional information such as status, measurement results, and/or location may be added by the AIoT devices and/or an AIoT RAN (Radio Access Network)/reader. Through the inventory service, AIoT devices within a predetermined range of a specific reader may be discovered and/or tracked.

A command service represents a procedure for executing commands for AIoT devices located in a specific area. The commands may include, for example, read, write, disable, and/or enable services.
Read: a request to read information from an AIoT device.
Write: a request to write information to an AIoT device.
Disable: a request to permanently or temporarily disable an RF transmission capability of an AIoT device.
Enable: a request to enable an AIoT device that has been temporarily disabled.

Connectivity topologies such as those shown in FIGS. 7A to 7B may be defined for an ambient Internet of Things (AIoT) network and devices. In FIG. 7A, a BS represents an ambient IoT Radio Access Network (RAN). The AIoT RAN represents a node that performs specific functions for AIoT as part of a functional split between a Radio Access Network (RAN) and a Core Network (CN), for example, a RAN node function that includes control of A-IoT radio resources used by an A-IoT device. The AIoT RAN may serve one or more AIoT readers. An AIoT reader represents a reader that terminates an AIoT protocol with an AIoT device. For convenience of description, the node may hereinafter be referred to as an AIoT RAN (or an AIoT reader). This is merely for convenience of description, and the node may be denoted by any other term, such as an AIoT RAN reader, an AIoT base station, or an AIoT BS reader.

In all of these topologies, a carrier may be provided to an AIoT device from another node inside or outside the topology. Links in each topology may be bidirectional or unidirectional. In FIG. 7A, an AIoT device communicates directly and bidirectionally with a base station. Communication between the base station and the AIoT device may include AIoT data and/or signaling. A base station that transmits to the AIoT device and a base station that receives from the AIoT device may be the same base station or may be different base stations.

In FIG. 7B, an AIoT device performs bidirectional communication with an AIoT RAN via an intermediate node/assisting node/assisting UE. In this topology, the intermediate node/assisting node/assisting UE may be a relay, an integrated access and backhaul (IAB) node, a UE, a repeater, or the like, which is capable of ambient IoT functions and/or services. For convenience of description, the node may hereinafter be referred to as a UE reader. This is merely for convenience of description, and the node may be denoted by any other term, such as a UE connected to or associated with an AIoT-enabled RAN, an AIoT-enabled RAN/reader, an AIoT reader, or an AIoT UE reader.

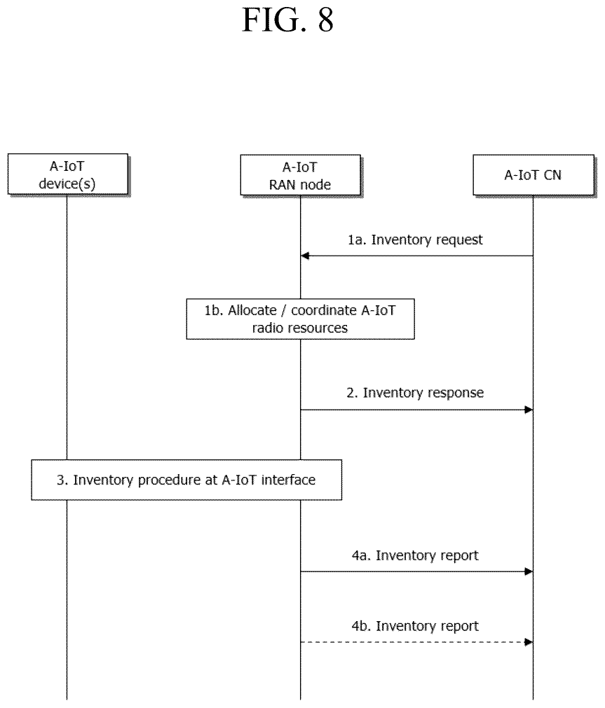

FIG. 8 illustrates an example of a procedure for an A-IoT inventory service.

With reference to FIG. 8, a procedure for an AIoT inventory service is described below.
1a. The A-IoT CN sends an inventory request message to an A-IoT RAN node.
1b. The A-IoT RAN node allocates and coordinates usage of A-IoT radio resources.
2. The A-IoT RAN node sends an inventory response message to the A-IoT CN.
3. The A-IoT RAN node performs an inventory procedure toward one or more A-IoT devices over an A-IoT radio interface.
4a/4b. After receiving inventory results from the one or more A-IoT devices, the A-IoT RAN node may transmit one or more inventory reports to the A-IoT CN, the inventory reports including the received inventory results.

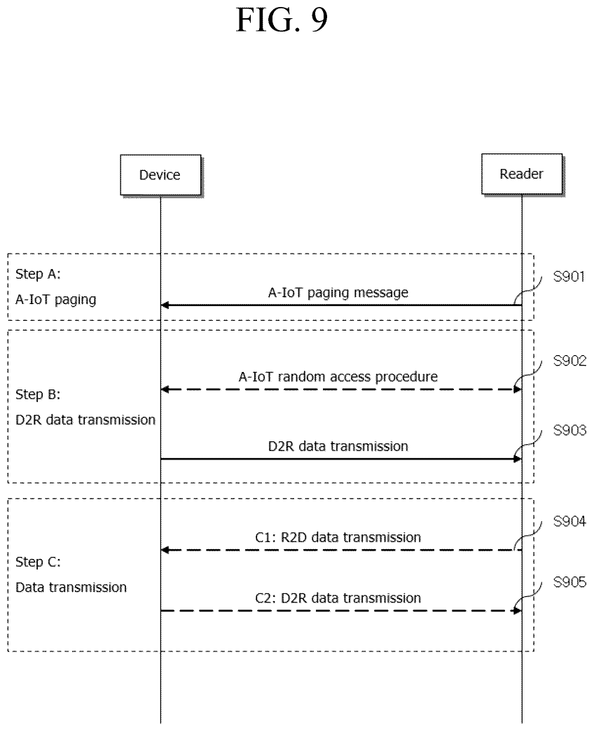

FIG. 9 illustrates an example of an access stratum (AS) procedure between an A-IoT device and a reader.

With reference to FIG. 9, an overall access stratum (AS) procedure between an ambient Internet of Things (A-IoT) device and a reader is described below.

### Step A: A-IoT Paging (S901)

Based on a service request, the reader transmits an A-IoT paging message indicating one or more devices that are required to respond. In this case, the A-IoT paging message may be used interchangeably with an initial trigger message.

### Step B: D2R (Device-to-Reader) Data Transmission (S902-S903)

One or more A-IoT devices triggered by the paging perform transmission of a device identity (ID) to the reader by performing an A-IoT random access procedure or without performing the A-IoT random access procedure. Thereafter, D2R data is transmitted to the reader.

### Step C1: R2D (Reader-to-Device) Data Transmission (S904)

A possible R2D data transmission is performed, for example, for transmitting a command.

### Step C2: D2R Data Transmission (S905)

A possible D2R data transmission is performed, for example, for transmitting a corresponding response to the command.

As such, although high-level procedures for providing an inventory service or a command service have been defined, detailed operations between an AIoT device and an AIoT RAN/reader for supporting AIoT services have not been provided, thereby preventing effective implementation of AIoT services. In particular, methods for R2D/D2R data transmission and reception between an AIoT device and an AIoT RAN/reader, which take AIoT characteristics into consideration, have not been provided.

In providing AIoT technologies that support lower complexity, smaller size, reduced capability, and lower power consumption compared to existing 3GPP LPWA (Low-Power Wide-Area) IoT, methods for R2D/D2R data transmission and reception that consider AIoT characteristics have not been provided.

To address these problems, the present disclosure proposes a method and an apparatus for effectively providing R2D/D2R data transmission between an AIoT device and an AIoT RAN/reader that takes AIoT characteristics into consideration.

Hereinafter, data transmission and reception methods based on 5GS (Fifth Generation System) and NR technologies are described in detail. However, this is merely for convenience of description, and the present disclosure may be applied based on any system or any radio access technology (for example, 6G). Embodiments described in the present disclosure may refer to information elements and operation details specified in NR/5GS standards (for example, TS 38.321 as an NR MAC specification, TS 38.331 as an NR RRC specification, and TS 23.501 as a system architecture specification). Even if definitions of such information elements and related terminal operations are not described in the present disclosure, corresponding contents specified in standard specifications as well-known technologies may be included in the present disclosure.

Any function described below may be defined as an individual terminal capability (for example, a UE radio capability or a UE core network capability) and may be transmitted by a terminal to a base station or a core network entity (for example, an AMF (Access and Mobility Management Function), an SMF (Session Management Function), or an AIoTNF (Ambient IoT Network Function)) through corresponding signaling. Alternatively, multiple functions may be combined or aggregated and defined as a terminal capability and may be transmitted by the terminal to the base station or the core network entity through corresponding signaling. Herein, an Ambient IoT Function (AIoTF) represents a network function for providing management and control of AIoT services and AIoT operations. This is merely for convenience of description, and the name may be changed to any other term. The AIoTF may select an AIoT RAN node (or a UE reader). The AIoTF may receive an AIoT service request from an application function or an application server and trigger an AIoT RAN/reader (or an AIoT UE reader) to perform AIoT device operations and AIoT service operations. The AIoTF may collect AIoT service operation results from the AIoT RAN node (or the AIoT UE reader) and transmit the collected results to the application function or the application server.

An ambient IoT device may be classified and defined into at least one device type or category according to at least one supported capability or a combination of at least one capability. For example, according to an energy storage capacity, devices may be classified into a device having no energy storage, a device having an energy storage capacity up to a specific value (up to E1 Joules), and a device having an energy storage capacity up to another specific value (up to E2 Joules, where E2>E1). As another example, devices may be classified into a device having no energy storage and no independent signal generation or amplification (for example, backscatter transmission) (hereinafter referred to as Device A for convenience of description), a device having an energy storage unit but no independent signal generation (for example, backscatter transmission) (hereinafter referred to as Device B for convenience of description), wherein use of stored energy in Device B may include amplification of a reflected signal, and a device having an energy storage unit and independent signal generation (for example, active RF components for transmission) (hereinafter referred to as Device C for convenience of description). As another example, devices may be classified into a device having approximately 1 ρW peak power consumption, having energy storage, having no amplification in both downlink (DL) and uplink (UL) within the device, and performing uplink transmission by backscattering on an externally provided carrier wave (hereinafter referred to as Device 1 for convenience of description); a device having peak power consumption of less than or equal to a few hundred ρW, having energy storage, having amplification in both DL and UL within the device, and performing uplink transmission by backscattering on an externally provided carrier wave (hereinafter referred to as Device 2a for convenience of description); and a device having peak power consumption of less than or equal to a few hundred ρW, having energy storage, having amplification in both DL and UL within the device, and performing uplink transmission using a carrier wave internally generated by the device (hereinafter referred to as Device 2b for convenience of description).

An AIoT RAN/reader/base station/UE reader or an AIoTF may transmit, indicate, or configure information or messages to an AIoT device to instruct enabling, activation, allowance, support, and/or configuration of any function or any combination of functions described below. For example, such information or messages may be transmitted from the AIoTF to the AIoT device through an AIoT NAS message or container. Alternatively, such information or messages may be transmitted to the AIoT device through a dedicated MAC PDU by an AIoT RAN/reader/base station/UE reader.

An AIoT RAN/reader/base station/UE reader or an AIoTF may transmit, indicate, or configure information or messages to an AIoT device to instruct disabling, deactivating, restricting, and/or controlling any function or any combination of functions described below. For example, a prohibit, suspend, or deactivate timer for operation of a corresponding function may be indicated. The timer may be started or restarted at initiation of the corresponding function or before or after initiation of the corresponding function. While the timer is running, the device may be disabled, deactivated, restricted, or controlled so as not to initiate or perform the corresponding function.

Embodiments and corresponding functions described below may be performed independently. Alternatively, the embodiments and functions described below may be arbitrarily combined or aggregated and implemented, and it is apparent that such implementations are also included within the scope of the present invention.

Any information described below may be traffic characteristic information obtained, calculated, or derived statistically or empirically by a terminal or a network (for example, arbitrary statistics or statistical values such as an expected value/average, variance, standard deviation, minimum, or maximum). Accordingly, any information included in the present specification may represent at least one of an average (expected value), a minimum, a maximum, or a standard deviation. This is merely for convenience of description, and all information in the present specification may be used as statistical information. Any information described below may be pre-configured in a device or a network, or may be provisioned through OAM (Operations, Administration, and Maintenance), an application server, an application function, AIoT, UDM (Unified Data Management), and/or ADM (AIoT Data Management).

Hereinafter, a physical channel for R2D (Reader to Device) data transmission is referred to as a PRDCH (Physical Reader to Device Channel), a physical channel for D2R (Device to Reader) data transmission is referred to as a PDRCH (Physical Device to Reader Channel), and an interface/link between a reader and a device is referred to as an RD interface/link (for example, an AIoT radio interface). This is merely for convenience of description, and may be replaced with any other term.

Hereinafter, RD/DR link resource and scheduling information may include at least one of:
a start time/subframe/slot/symbol/reference time/arbitrary AIoT device unit time (for RD/DR link communication);
a start time/subframe/slot/symbol/reference time/arbitrary AIoT device unit time offset (for RD/DR link communication);
a start time/subframe/slot/symbol based on a specific reference time/point (for example, R2D data reception, start of R2D data reception, end of R2D data reception, or a serving base station/cell-specific reference time serving the corresponding reader);
a start time/subframe/slot/symbol offset based on a specific reference time (for RD/DR link communication);
a duration (for RD/DR link communication);
a transmission occasion (for an RD/DR link);
a transmission period (for an RD/DR link);
available time slots;
an available time-slot range;
a maximum number of time slots;
an uplink/downlink start time/subframe/slot/symbol and/or a start time/subframe/slot/symbol offset of an associated base station or assisting terminal for indicating an RD link start time;
frequency-domain information of an RD link;
an RD link subchannel number/index;
a DR link frequency offset;
an RD/DR link MCS;
an RD/DR link transport block size;
a communication range;
location information;
a priority;
a number of retransmissions for an RD/DR link; and
a validity period/time and/or a validity criterion (for RD/DR link communication).

### Processing of Data, Device Variables, State Information, Counters, and Timers Based on Availability of an AIoT Device

An AIoT device needs to be implemented with minimal specifications in order to support ultra-low complexity. Memory included in the AIoT device may be classified into two types. First, non-volatile memory may be supported to store information that is permanently stored. Next, a register may be supported to temporarily maintain information required for performing any service or operation of the AIoT device while energy is available in an energy storage unit (for example, a capacitor). The non-volatile memory may store or be configured with at least one of a device ID of the AIoT device, pre-configured radio resource configuration parameters, and pre-configured default parameters. The register (or volatile memory or temporary storage memory when the AIoT device is available) may store or be configured with at least one of temporary radio resource configuration parameters required for performing a specific AIoT service operation in the AIoT device, device variables, state variables, counters, and timers.

For example, when an AIoT device is in an available state (for example, a state in which data transmission and reception are available or possible, a state in which an operation for any or a specific AIoT service or operation is available or possible, or a state in which energy stored, harvested, or charged in the AIoT device exceeds a predetermined level), at least one of pre-configured radio resource configuration parameters, temporary radio resource configuration parameters, device variables, state variables, counters, and timers may be indicated, set, applied, changed, configured, stored, started, executed, stopped, expired, incremented, initialized, or maintained. For example, the AIoT device may receive radio resource configuration or setting information or a profile through an NAS message or container from an AIoTF and may set, apply, change, configure, or store corresponding radio resource configuration parameters. Alternatively, when the AIoT device receives a specific MAC PDU from an AIoT RAN or reader, the AIoT device may store, update, initialize, increment, start, or stop related device variables, state variables, counters, or timers.

As another example, when an AIoT device transitions to an unavailable state, is deactivated, or is disabled (for example, a state in which data transmission and reception are unavailable, impossible, or deactivated; a state in which an operation for any or a specific AIoT service or operation is unavailable, impossible, or deactivated; or a state in which energy stored, harvested, or charged in the AIoT device falls below a predetermined level), at least one of the aforementioned temporary radio resource configuration parameters, device variables, state variables, counters, and timers may be initialized, released, deleted, removed, lost, discarded, or reset to default values.

As another example, when the AIoT device receives an R2D message or data, based on any or specific field(s) or information included in a header of a MAC PDU of the corresponding R2D message or data (or a MAC PDU or control element (CE) including the corresponding R2D message or data), and/or based on any or specific field(s) or information included in a header of an NAS message or container included in the corresponding R2D message MAC PDU (or included in the NAS message or container), at least one of pre-configured radio resource configuration parameters, temporary radio resource configuration parameters, device variables, state variables, counters, and timers may be indicated, set, applied, changed, configured, stored, started, executed, stopped, expired, incremented, or initialized in a MAC layer/entity and/or an NAS layer/entity.

### Processing of Data, Device Variables, State Information, Counters, and Timers in an AIoT Device During a D2R Data Transmission Procedure

One of the representative AIoT use cases, an inventory procedure, may be provided based on step A and step B of FIG. 9. An AIoT device may perform D2R data transmission after receiving an AIoT paging message in step A, after receiving an AIoT message 2 (message2, MSG2) in step B, or after the AIoT random access procedure in step B.

A command procedure may be provided based on step A, step B, step C1, and step C2. An AIoT device may perform D2R data transmission after receiving an AIoT paging message in step A, after receiving AIoT MSG2 in step B, or after the AIoT random access procedure in step B, and after R2D data transmission in step C1.

For the D2R data transmission, the AIoT device may transmit a D2R message/data based on scheduling information (e.g., an access occasion, a frequency band/sub-band/resource/resource set, a transport block size, modulation, coding, etc.) included in a (most recent/previous) R2D message received from a reader and/or based on scheduling information determined at a MAC layer of the AIoT device.

The D2R data may be provided together with an AIoT message 1 (message1, MSG1) or may be provided without AIoT MSG1.

For example, D2R data (a MAC SDU) may be included in an AIoT MSG1 MAC PDU. The AIoT MSG1 MAC PDU may be composed of one corresponding MAC header and one MAC SDU.

As another example, the AIoT MSG1 and the D2R data may be transmitted via respective MAC sub-PDUs. One corresponding MAC PDU may be composed of one AIoT MSG1 MAC sub-PDU and one D2R data MAC sub-PDU. The AIoT MSG1 MAC sub-PDU may be composed of one corresponding MAC subheader and one MAC MSG1 CE. Alternatively, the AIoT MSG1 MAC sub-PDU may be composed of only one corresponding MAC subheader.

If the AIoT device does not have upper-layer data to transmit when transmitting AIoT MSG1, the AIoT MSG1 MAC PDU may be configured to include one corresponding MAC header and one MAC MSG1 CE. Alternatively, the AIoT MSG1 MAC PDU may be configured to include only one corresponding MAC header.

During D2R data transmission that includes upper-layer data, the MAC layer/entity may support segmentation over the D2R link (or the R2D link) between the AIoT device and the AIoT RAN/reader. When triggered or indicated by an AIoT service request (and/or by the AIoT RAN/reader), if the size of one MAC PDU including the D2R data to be transmitted by the AIoT device is larger than the size of the scheduling resource/transmission block received or determined at the AIoT device, the AIoT device may support segmentation at the MAC layer/entity.

For example, when the size of one MAC SDU including upper-layer data plus a MAC header within one MAC PDU is larger than the size of the scheduling resource/transmission block received or determined at the AIoT device, data/bit strings/bytes/bits of the upper-layer data that fit the received or determined scheduling resource/transmission block (e.g., up to a portion of the upper-layer data such that the size of the MAC header plus the portion of the upper-layer data included in a segment is equal to or less than the size provided by the scheduled resource/transmission block) may be included in one segment and configured accordingly. The segment may be configured as one MAC PDU including one MAC header having at least one information field and one MAC SDU including the corresponding portion of the upper-layer data.

In another example, when the cumulative size obtained by adding respective MAC subheaders to one or more MAC SDUs including one or more upper-layer data (e.g., one or more AIoT NAS messages and/or one or more AIoT data) to be included in one MAC PDU is larger than the size of the scheduling resource/transmission block received or determined at the AIoT device, data/bit strings/bytes/bits up to a portion that fits the received or determined scheduling resource/transmission block (e.g., up to a portion of the last upper-layer data such that the cumulative size of each upper-layer data plus its corresponding MAC subheader included in the segment is equal to or less than the size provided by the scheduled resource/transmission block) may be included in one segment and configured accordingly. For example, when the segment is composed of two upper-layer data, the entire first upper-layer data and only a portion of the second upper-layer data may be included and transmitted. The segment may be configured as one MAC PDU including one or more corresponding MAC subheaders and one MAC SDU including the entire or partial corresponding upper-layer data.

The bit order of each parameter field within a MAC PDU may be represented such that the first and most significant bit is the leftmost bit, and the last and least significant bit is the rightmost bit.

To support the segmentation function, the AIoT device may store the corresponding segment information in a register (or volatile memory, or a temporary storage memory available when the AIoT device is in an available state).

For example, the segment information may be buffered/stored at the AS layer (i.e., the MAC layer). The AIoT device may indicate, to an upper layer (AIoT NAS or AIoT data/application), as segment information, indication information resulting from MAC header processing of a MAC PDU received from the AIoT RAN/reader and/or fields/information included in the MAC header and/or upper-layer data (e.g., an AIoT NAS message/container or AIoT (application) data) included in the MAC PDU. The AIoT device may receive, from the upper layer, indication information according to upper-layer processing and/or upper-layer data (e.g., an AIoT NAS message/container or AIoT (application) data).

The upper-layer data may be information including the header of the corresponding upper layer and may be associated with a single MAC SDU. One or more pieces of upper-layer data may be included in and processed as a single MAC SDU. Alternatively, each piece of upper-layer data may be processed as a respective MAC SDU. (As another option, the upper-layer data may be payload information of the corresponding upper layer that does not include the upper-layer header.)

The AIoT device may store the corresponding upper-layer data at the MAC layer. Based on D2R scheduling information received from the AIoT RAN/reader (and/or based on D2R scheduling information determined at the MAC layer of the AIoT device), the AIoT device may generate a MAC PDU to be transmitted. If segmentation is performed for any reason (e.g., when the size obtained by adding a MAC header to the upper-layer data included in the MAC PDU is larger than the received scheduling resource), the AIoT device may store the corresponding segment information at the MAC layer. The AIoT device may transmit the MAC PDU or the corresponding segment to the AIoT RAN/reader. When the AIoT device receives, from the AIoT RAN/reader, a retransmission indication for the MAC PDU or the corresponding segment based on the segment information, for example, when a retransmission indication is received due to no data being received via the segment information (e.g., the received data size is zero), the AIoT device may retransmit the corresponding MAC PDU or the corresponding segment (e.g., a segment from the starting byte of the original upper-layer data to the ending byte of the segment) to the AIoT RAN/reader. Alternatively, when the AIoT device receives, from the AIoT RAN/reader via the segment information, received data segment size information (e.g., information indicating that the received data size corresponds to the ending byte of the original upper-layer data), the AIoT device may transmit the corresponding MAC PDU or the corresponding segment (e.g., a segment starting from the byte obtained by adding one to the ending byte of the transmitted segment of the original upper-layer data) to the AIoT RAN/reader.

The segment information may indicate, in units of bytes/bits, position information of a corresponding MAC SDU segment within the corresponding/original MAC SDU (or, alternatively, the segment information may indicate, in units of bytes/bits, position information of a corresponding MAC PDU segment within the corresponding/original MAC PDU). The segment information may indicate, in units of bytes/bits, the start/first byte/bit of the corresponding MAC SDU/PDU segment within the corresponding/original MAC SDU/PDU. And/or, the segment information may indicate, in units of bytes/bits, the end/last byte/bit of the corresponding MAC SDU/PDU segment within the corresponding/original MAC SDU/PDU. And/or, the segment information may indicate, in units of bytes/bits, the start/first byte/bit of the MAC SDU/PDU segment to be transmitted by the device within the corresponding/original MAC SDU/PDU; for example, it may indicate the value obtained by adding one to the end/last byte/bit of a previously transmitted MAC SDU/PDU segment that has been successfully received by the reader. And/or, the segment information may indicate, in units of bytes/bits, the end/last byte/bit of a previously transmitted MAC SDU/PDU segment from the device within the corresponding/original MAC SDU/PDU, for example, it may indicate the end/last byte/bit of a previously transmitted MAC SDU/PDU segment that has been successfully received by the reader. And/or, the segment information may be associated with the corresponding MAC SDU/PDU as a device variable. For convenience of explanation, an example is provided below. This example is provided for illustrative purposes only, and the present disclosure is not limited thereto. If a MAC SDU received from an upper layer is 100 bytes, and in a first D2R scheduling decision 30 bytes are determined to be transmitted excluding the MAC header (or 45 bytes including the MAC header), and in a second D2R scheduling decision 70 bytes are determined to be transmitted excluding the MAC header (or 85 bytes including the MAC header), then, according to the first D2R scheduling, the start position of the segment to be transmitted may be 0 and the end position may be 30. According to the second D2R scheduling, the start position of the segment to be transmitted may be 30+1 and the end position may be 100. Alternatively, according to the first D2R scheduling, the start position of the segment to be transmitted may be 0 and the end position may be 45, and according to the second D2R scheduling, the start position of the segment to be transmitted may be 45+1 and the end position may be 130.

In another example, the segment information may be included in the corresponding D2R/R2D MAC PDU (or a MAC PDU header). For example, an R2D MAC PDU for indicating transmission of a D2R MAC PDU including upper-layer data may include the segment information within the MAC PDU. The segment information may indicate size information of data/segments received by the reader from the device, for example, the end/last byte of an original MAC SDU previously transmitted by the device and/or the start/first byte of the original MAC SDU to be transmitted by the device after the corresponding R2D MAC PDU.

In another example, information for indicating success/failure of a corresponding segment transmission, which is transmitted by the AIoT RAN/reader to the AIoT device, may include the corresponding segment information or segment information included in a subsequent/next/follow-up transmission. For example, when the AIoT RAN/reader successfully receives a segment transmitted by the AIoT device, the AIoT RAN/reader may include the segment information corresponding to the successfully received segment. The segment information may indicate size information of the data/segment successfully received by the reader from the device, for example, the end/last byte and/or the start/first byte of the original MAC SDU that was transmitted by the device via a previous D2R MAC PDU and successfully received by the reader. Alternatively, the segment information may indicate, based on the size information of the data/segment successfully received by the reader from the device (e.g., the end/last byte and/or the start/first byte of the original MAC SDU successfully received via a previous D2R MAC PDU), segment information for a subsequent/follow-up D2R MAC PDU for transmission, for example, the start/first byte and/or the end/last byte of the original MAC SDU to be transmitted by the device via the subsequent D2R MAC PDU. As another example, when the AIoT device fails to transmit the corresponding segment according to the D2R scheduling indicated by the reader, or when the reader fails to receive the corresponding segment, the AIoT RAN/reader may include information of a previously successfully received segment (e.g., the end/last byte and/or the start/first byte of the original MAC SDU successfully received by the reader via a previous D2R MAC PDU) or segment information for a subsequent/next/follow-up transmission/retransmission by the AIoT device (e.g., the start/first byte and/or the end/last byte of the original MAC SDU to be transmitted by the device via a subsequent D2R MAC PDU).

In another example, when the AIoT device transmits a segment to the AIoT RAN/reader, the AIoT device may store the corresponding segment information as a device variable. If segment information different from the segment information of the currently transmitted segment is stored in the device variable, the segment information associated with the device variable may be updated/modified/changed.

In another example, when the AIoT device transmits a MAC PDU or a segment to the AIoT RAN/reader and receives, from the AIoT RAN/reader, information indicating successful reception of the MAC PDU or the segment, the segment information stored in the device variable may be updated/disposed/discarded/deleted/removed. For example, when the AIoT device receives, via segment information, size information of data/segments successfully received by the reader from the device, if there is previously stored segment information for the device, the AIoT device may update/dispose/discard/delete/remove the previously stored segment information.

In another example, the segment information may be buffered/stored at an upper layer (an AIoT NAS layer or an AIoT data/application layer). The AIoT device may indicate, from the MAC layer to the upper layer (the AIoT NAS or AIoT data/application layer), indication information resulting from MAC header processing in a MAC PDU received from the AIoT RAN/reader and/or fields/information included in the MAC header and/or upper-layer data (e.g., an AIoT NAS message/container or AIoT (application) data) included in the MAC PDU. The information indicated to the upper layer may include information for indicating the size/volume/amount of upper-layer data to be included in a MAC PDU for generation, based on scheduling information received by the AIoT device from the AIoT RAN/reader at the MAC layer (and/or based on scheduling information determined at the MAC layer of the AIoT device). The upper-layer data may represent data including an upper-layer header, or may represent payload data of the upper layer that does not include the upper-layer header.

The information indicated to the upper layer may include segment transmission indication information or retransmission indication information for a previously transmitted segment.

Based on the received information, an upper layer (an AIoT NAS layer and/or an AIoT data/application layer) of the AIoT device may generate a MAC SDU (or upper-layer data, an AIoT NAS PDU, or an AIoT data/application PDU) for indication/submission/delivery to the MAC layer.

The AIoT device may store the upper-layer data at the corresponding upper layer (one or more of the AIoT NAS layer and the AIoT data/application layer). Alternatively, the AIoT device may store the upper-layer data at the AIoT NAS layer.

The AIoT device may determine whether segmentation is to be performed at the corresponding upper layer (the AIoT NAS layer or the AIoT data/application layer) based on information received from the MAC layer. Alternatively, the AIoT device may determine whether segmentation is to be performed at the MAC layer and indicate/deliver corresponding indication information to the upper layer/AIoT NAS layer.

If segmentation is performed, for example, when the size of the corresponding upper-layer data (e.g., an AIoT NAS PDU or an AIoT data/application PDU) is larger than the data size (e.g., the size/volume/amount of upper-layer data to be included in a MAC PDU) based on information received from the MAC layer, and/or when segmentation-related information is received from the MAC layer, the AIoT device may store the segment information at the corresponding upper layer/AIoT NAS layer. The AIoT device may deliver/submit/indicate the corresponding segment (or MAC SDU(s)) from the upper layer/AIoT NAS layer to the MAC layer. The AIoT device may indicate/deliver, from the upper layer/AIoT NAS layer to the MAC layer, indication information resulting from upper-layer processing and/or the segment information. The AIoT device may transmit the corresponding MAC PDU or the corresponding segment from the MAC layer to the AIoT RAN/reader. When the AIoT device receives, from the AIoT RAN/reader via segment information, a retransmission indication for the corresponding MAC PDU or the corresponding segment, the MAC layer of the AIoT device may indicate the corresponding indication information to the upper layer. The AIoT device may deliver/submit/indicate the corresponding MAC PDU or segment (or MAC SDU) from the upper layer/AIoT NAS layer to the MAC layer, and the AIoT device may transmit the corresponding MAC PDU or the corresponding segment from the MAC layer to the AIoT RAN/reader.

The segment information may indicate position information of a MAC SDU segment within the corresponding/original MAC SDU in units of bytes/bits. Alternatively, the segment information may indicate position information of a MAC SDU segment within the corresponding/original MAC PDU in units of bytes/bits.

The segment information may indicate, in units of bytes/bits, the start/first byte/bit of the corresponding MAC SDU/PDU segment within the corresponding/original MAC SDU/PDU. And/or, the segment information may indicate, in units of bytes/bits, the end/last byte/bit of the corresponding MAC SDU/PDU segment within the corresponding/original MAC SDU/PDU. And/or, the segment information may indicate, in units of bytes/bits, the start/first byte/bit of a MAC SDU/PDU segment to be transmitted within the corresponding/original MAC SDU/PDU. For example, it may indicate the end/last byte/bit of a previously transmitted MAC SDU/PDU segment that has been successfully received by the reader plus one.

And/or, the segment information may indicate, in units of bytes/bits, the end/last byte/bit of a previously transmitted MAC SDU/PDU segment within the corresponding/original MAC SDU/PDU. For example, it may indicate the end/last byte/bit of a previously transmitted MAC SDU/PDU segment that has been successfully received by the reader. The segment information may be associated with the corresponding MAC SDU/PDU as a device variable.

The segment information may indicate position information of a NAS/data PDU segment within the corresponding/original NAS/data PDU in units of bytes/bits. The segment information may indicate, in units of bytes/bits, the start/first byte/bit of the corresponding NAS/data PDU segment within the corresponding/original NAS/data PDU. And/or, the segment information may indicate, in units of bytes/bits, the end/last byte/bit of the corresponding NAS/data PDU segment within the corresponding/original NAS/data PDU. And/or, the segment information may indicate, in units of bytes/bits, the start/first byte/bit of a NAS/data PDU segment to be transmitted within the corresponding/original NAS/data PDU. For example, it may indicate the end/last byte/bit of a previously transmitted NAS SDU/PDU segment that has been successfully received by the reader plus one. And/or, the segment information may indicate, in units of bytes/bits, the end/last byte/bit of a previously transmitted NAS/data PDU segment within the corresponding/original NAS/data PDU. For example, it may indicate the end/last byte/bit of a previously transmitted NAS SDU/PDU segment that has been successfully received by the reader. And/or, the segment information may be associated with the corresponding NAS/data PDU as a device variable.

In another example, the segment information may be included in a NAS PDU (or a NAS PDU header) or in a MAC PDU (or a MAC PDU header). For example, an AIoT RAN/reader that has successfully received one segment transmitted by an AIoT device may include, in a corresponding R2D MAC PDU, information indicating the size of the successfully received upper-layer data/segment (e.g., the end/last byte/bit of the successfully received upper-layer data/segment, and/or the start/first byte/bit of an upper-layer data/segment to be subsequently transmitted after the successfully received upper-layer data/segment).

In another example, information transmitted by the AIoT RAN/reader to the AIoT device for indicating success/failure of the segment transmission may include the segment information or segment information to be included in a subsequent/next/follow-up transmission. For example, the AIoT RAN/reader may include information indicating the size of upper-layer data/segment that has been successfully received by the reader, and/or information indicating the size of upper-layer data/segment to be included in a subsequent/next/follow-up transmission.

In another example, when the AIoT device delivers/submits/indicates a segment (or a MAC SDU) from the upper layer/AIoT-NAS layer to the MAC layer, the AIoT device may store the segment information as a device variable. If segment information different from the segment information of the currently transmitted segment is stored in the device variable, the AIoT device may update/modify/change the segment information.

In another example, when the AIoT device delivers/submits/indicates a segment (or a MAC SDU) from the upper layer/AIoT-NAS layer to the MAC layer and receives, from the MAC layer, information indicating success for the corresponding segment (or MAC SDU), the AIoT device may update/dispose/discard/delete/remove the segment information associated with the device variable.

Hereinafter, another embodiment of the present disclosure will be described.

As described above, the AIoT service needs to support various AIoT use cases, such as inventory, sensing, positioning, and command. For example, an AIoT AS procedure may be provided based on step A and step B of FIG. 4, or may be provided based on step A, step B, step C1, and step C2 of FIG. 9. In step B or step C of FIG. 9, an AIoT device may perform D2R data transmission.

As one example, if the AIoT device selects contention-free random access in step B of FIG. 9 (and/or if the AIoT device receives explicit or implicit information for indicating contention-free random access from the AIoT RAN/reader (e.g., one or more of a dedicated D2R access occasion/resource/frequency resource/scheduling information for the device, or an AS ID)), the AIoT device may transmit D2R data including AIoT device identification information and/or upper-layer data on the dedicated D2R access occasion/resource/frequency resource.

As another example, if the AIoT device selects contention-based random access in step B of FIG. 9, the AIoT device may transmit a D2R message (AIoT MSG1) and/or data including at least one of a random ID, AIoT device identification information, and upper-layer data on the corresponding D2R access occasion/resource/frequency resource.

As another example, if the AIoT device selects contention-based random access in step B of FIG. 9, transmits AIoT MSG1, and subsequently receives AIoT MSG2 from the AIoT RAN/reader, the AIoT device may transmit a D2R message (AIoT MSG3) and/or data including at least one of AIoT device identification information and upper-layer data on the received dedicated D2R access occasion/resource/frequency resource.

As another example, in step C of FIG. 9, the AIoT device may transmit D2R data including at least one of AIoT device identification information and upper-layer data on a dedicated D2R access occasion/resource/frequency resource based on an AS ID and dedicated scheduling information received from the AIoT RAN/reader.

As in the above-described embodiments, although the AIoT device performs D2R data transmission in step B or step C of FIG. 9, the AIoT RAN/reader may fail to receive all or part of the corresponding D2R data. The AIoT RAN/reader may include, in an arbitrary R2D message/data (e.g., AIoT paging, AIoT MSG2, or R2D data), dedicated scheduling information for transmission of a response/subsequent/associated/next D2R message/data (e.g., AIoT MSG1, AIoT MSG3, or D2R data). If the AIoT RAN/reader fails to receive the corresponding D2R data from the AIoT device until the scheduling (and/or a validity time/validity criterion of the scheduling, or a duration from when the scheduling is indicated by the AIoT RAN/reader to an expected reception of the D2R data) expires, the AIoT RAN/reader may explicitly and/or implicitly indicate information for indicating the D2R data reception failure, thereby allowing the AIoT device to transmit or retransmit the corresponding D2R data.

As one example, a (dedicated) R2D MAC PDU/CE for indicating a D2R data reception failure may be defined. The MAC PDU/CE may be distinguished by at least one of: information for identifying the MAC PDU/CE within a MAC header; information for identifying a format of the MAC PDU/CE; information for indicating that the MAC PDU/CE is a MAC PDU/CE for indicating a D2R data reception failure; logical channel identification information included in the MAC PDU/CE; PDU type/type-of-data identification information/control-PDU type information included in the MAC PDU/CE; and service type information included in the MAC PDU.

As another example, AIoT MSG2 may be used as an R2D MAC PDU for indicating a D2R data reception failure. The AIoT MSG2 MAC PDU may include at least one of: a 16-bit random ID received from the AIoT device via AIoT MSG1; D2R access occasion/resource/frequency resource/scheduling information; an AS ID allocated by the AIoT RAN/reader and used for D2R scheduling (and/or R2D reception); and information/fields for indicating whether a D2R data reception failure has occurred.

As another example, a (dedicated) R2D MAC PDU/CE for indicating a D2R data reception failure or an AIoT MSG2 MAC PDU/CE for indicating a D2R data reception failure may include, in the MAC PDU (or in the MAC PDU header), (1-bit) information/fields for indicating whether reception of AIoT MSG3 has failed.

As another example, when the AIoT device receives the R2D message, if, based on MAC PDU header information, the MAC PDU is an AIoT MSG2 MAC PDU, and the random ID included in the AIoT MSG2 MAC PDU has the same value as the 16-bit random ID transmitted by the AIoT device via AIoT MSG1, and/or the AS ID included in the AIoT MSG2 MAC PDU has the same value as the AS ID received by the AIoT device via a paging message (or a paging MAC PDU or a paging MAC header), and/or the AS ID included in the AIoT MSG2 MAC PDU has the same value as the AS ID received by the AIoT device via an R2D message, the AIoT device may consider the AIoT MSG2 as an AIoT MSG2 intended for the AIoT device and may receive/process it.

To perform such checking, when the AIoT device receives an AS ID via a paging message (or a paging MAC PDU or a paging MAC header) and/or an R2D message, the AIoT device may store the AS ID as a device variable. If the device variable is already stored with a different value, the stored value may be replaced.

To perform such checking, when the AIoT device generates a random ID or transmits AIoT MSG1, the AIoT device may store the random ID as a device variable. If the device variable is already stored with a different value, the stored value may be replaced.

The random ID and/or the AS ID may be stored for each piece of information for distinguishing paging associated with a corresponding IoT service request (or together with/associated with such information). Alternatively, the random ID and/or the AS ID may be stored regardless of information for distinguishing paging associated with an IoT service request.

As another example, when AIoT MSG2 is used as an R2D MAC PDU for indicating a D2R data reception failure, the MAC PDU may be configured not to include upper-layer data (or an upper-layer data field, e.g., a dedicated AIoT NAS container field). The MAC PDU header may be configured not to include a field indicating the presence of upper-layer data. Alternatively, the MAC PDU header may indicate, via a field for indicating the presence of upper-layer data, that the corresponding AIoT MSG2 is used to indicate a D2R data reception failure.

As another example, when a D2R data reception failure occurs, the AloT device may be enabled to effectively handle the D2R data reception failure of the AIoT RAN/reader in consideration of an (energy) unavailable state of the AIoT device. For this purpose, a dedicated R2D MAC PDU (or indication information included in an R2D MAC PDU) may be defined.

When the AIoT device receives an R2D MAC PDU (or indication information included in an R2D MAC PDU) for indicating a D2R data reception failure of the AIoT RAN/reader, an R2D MAC PDU (or indication information included in an R2D MAC PDU) may be defined/used to support effective operation in a case where device variables, state information, counters, and/or timers that are stored on a short-term/temporary basis in the AIoT device have been lost.

An R2D MAC PDU for indicating a D2R data reception failure may include one or more of the following information/fields: the 16-bit random ID received from the AIoT device via AIoT MSG1 included in AIoT MSG2, D2R access occasion/resource/frequency resource/scheduling information, and the AS ID allocated by the AIoT RAN/reader used for D2R scheduling (and/or R2D reception).

In addition, the R2D MAC PDU for indicating D2R data reception failure may include AIoT device identification information (or any information stored in the AIoT device's non-volatile memory). This information may be the same as the AIoT device identification information included in an AIoT paging message (or paging MAC PDU or paging MAC header).

The R2D MAC PDU for indicating D2R data reception failure may also include information/fields for indicating whether the AIoT device identification information is included, information for indicating whether the AS ID is included, and one or more AS ID values.

The AIoT RAN/reader may omit the AIoT device identification information when first transmitting the R2D MAC PDU after the AIoT random access procedure. Subsequently, when the AIoT RAN/reader transmits or retransmits the R2D MAC PDU, it may include the AIoT device identification information.

The AIoT RAN/reader may omit the AIoT device identification information when first transmitting the R2D MAC PDU. Subsequently, when the AIoT RAN/reader transmits or retransmits the R2D MAC PDU, it may include the AIoT device identification information.

An R2D MAC PDU for indicating D2R data reception failure may have a MAC PDU format distinguishable from an AIoT MSG2 that does not include AIoT device identification information. For example, it may be distinguished based on at least one of the following: information within the MAC header for identifying the MAC PDU, information for distinguishing the MAC PDU format, logical channel identifier included in the MAC PDU, PDU type/data type identification/Control-PDU-type, or service type information included in the MAC PDU. Alternatively, an R2D MAC PDU for indicating D2R data reception failure may include information indicating whether AIoT device identification information is included.

When an AIoT device receives the R2D message, it may determine, based on the MAC PDU header information, whether the MAC PDU is an AIoT MSG2 MAC PDU (or an R2D MAC PDU for indicating D2R data reception failure). If the AIoT device identification information included in the AIoT MSG2 MAC PDU matches the AIoT device's own identification information, the AIoT MSG2 (or the R2D MAC PDU indicating D2R data reception failure) may be considered a MAC PDU intended for that AIoT device, and the device may receive it. If an AS ID is received, the AIoT device may store the received AS ID in a device variable. If the device variable already contains a different value, it may be replaced with the received AS ID.

In another example, information/fields for indicating D2R data reception failure may be included in a paging message (or a paging MAC PDU or paging MAC header).

In another example, one or more pieces of information included in the paging message may be included in a MAC PDU (or MAC header) for indicating D2R data reception failure. This allows the AIoT device, in the event of entering an unavailable state, to fall back to actions for MSG1 transmission and effectively perform the AIoT AS procedure.

Even when the AIoT device is in an available state, if it receives an R2D MAC PDU having a value different from a stored device variable, the device may perform actions for MSG1 transmission to transmit AIoT MSG1. If the AIoT device is in an available state and receives an R2D MAC PDU having the same value as the stored device variable, it may perform subsequent D2R data transmission according to the information included in that R2D MAC PDU.

A paging MAC PDU that includes information (or has the corresponding information set) for indicating D2R data reception failure may have a different MAC PDU format from a paging MAC PDU that does not include such information (or has the corresponding information unset). For example, it may be distinguished through at least one of: information in the MAC header for identifying the MAC PDU, information for distinguishing the MAC PDU format, logical channel identification information included in the MAC PDU, and/or PDU-type/data type identification/Control-PDU-type and service type information included in the MAC PDU. Alternatively, the MAC header may not include one or more information/fields contained in a paging message associated with an AIoT service request.

Alternatively, a paging MAC PDU that includes information (or has the corresponding information set) for indicating D2R data reception failure may include information for indicating whether such D2R data reception failure information is included.

Through one or more of the above-described operations, the AIoT device can more easily perform subsequent AIoT device operations. And/or the AIoT device can more easily transmit the response or subsequent D2R messages expected by the AIoT RAN/reader. This allows the AIoT RAN/reader to initiate the AIoT service procedure through paging associated with the AIoT service request. Alternatively, it can reduce the burden on the AIoT device of having to attempt access from the beginning again.

When the AIoT device transmits or receives AIoT MAC PDUs at the MAC layer, it is preferable to configure the MAC PDU taking into account the priority of the fields within the MAC header of the MAC PDU, to facilitate processing at the AIoT device. The following methods can be used to support this.

For example, if the AIoT device supports multiplexing of one or more MAC SDUs (data PDUs received from the upper layer) or MAC CEs (control elements, control messages/data generated by the MAC layer, MAC layer's own data, or a MAC PDU consisting only of a MAC header including one or more fields; for convenience of description, referred to as MAC CE, but may be replaced with other terms such as MAC PDU/message), the MAC CE can be prioritized over a MAC PDU containing a MAC SDU and positioned first/leftmost within a single MAC PDU.

The bit order of each parameter field within a MAC PDU may be represented with the first and most significant bit in the leftmost position and the last and least significant bit in the rightmost position.

In another example, if the AIoT device and/or AIoT RAN/reader does not support multiplexing in the MAC layer, the MAC PDU may be configured such that the MAC header is prioritized over the MAC SDU and positioned first/leftmost.

In another example, if the AIoT device and/or AIoT RAN/reader configures a MAC PDU in the MAC layer to include both a MAC PDU with only a single MAC header and a single MAC SDU in one MAC PDU, the MAC PDU with only the MAC header may be prioritized over the MAC SDU and positioned first/leftmost.

In another example, the MAC header included in the R2D/D2R MAC PDU between the AIoT device and AIoT RAN/reader, if included, may include at least one of the following:
Information to support forward compatibility for the MAC PDU (e.g., protocol version/release/format type/service type version);
Information to distinguish the MAC PDU type (e.g., PDU-type/data type identifier/Control-PDU-type and/or logical channel identifier and/or AIoT message/service type information for the MAC PDU and/or single/group/multiple device identification information, and information to indicate the reception success/failure of D2R messages/data/segments transmitted by the AIoT device);
Information to identify the AIoT device (e.g., information/field indicating the presence of AIoT device identification, AIoT device identification, information/field indicating the presence of AS ID (Access Stratum Identifier) (or information indicating the presence of the AIoT device ID and its length field), AS ID, group device identification, device identification for multiple devices, device identification for a single device);
Information to support efficient AIoT message/signaling/data transmission and reception (e.g., information/identifier for determining whether the AIoT device should skip a response to a paging message, information to identify/distinguish a single AIoT service request/trigger requested in one core network, information indicating reception success/failure of D2R messages/data/segments transmitted by the AIoT device);
For R2D messages, scheduling information for the subsequent D2R message/data of the R2D, and information to indicate the presence of upper layer data/NAS message/container.

The order of the information/fields in the above example is merely illustrative, and other orders of the information/fields are also within the scope of the present disclosure.

For example, an AIoT paging message may include, with highest priority, information to distinguish the type of the R2D MAC message. The AIoT paging message may also include information indicating the presence of AIoT device identification with higher priority than D2R scheduling information. The AIoT device may attempt transmission in response when a match occurs, based on matching its own device identification. Therefore, the information indicating the presence of AIoT device identification and the AIoT device identification itself may be included with higher priority than the D2R scheduling information.

For another example, an AIoT paging message may include AIoT device identification through the paging ID field. The device identification may support multiple types or options of bits. For instance, a typical AIoT device identification is known to be 96 bits or 128 bits. A permanent AIoT device identifier, which includes ID type, PLMN ID, NID, and Third Party ID, may be up to 196 bits or 228 bits. Filtering information that may be used for group AIoT device identification may add a 3-bit filtering type to the permanent AIoT device identifier format, resulting in a value of up to 199 bits or 231 bits. If the paging ID length field is 8 bits, 256 values may be distinguished, allowing the inclusion of the AIoT device identification mentioned above.

However, for applications that require device identification larger than 96 bits or 128 bits (or the permanent AIoT device identifier up to 196 bits or 228 bits), for example, in healthcare or global logistics, the paging method using the aforementioned 8-bit length may not be sufficient. To address this, the following methods may be considered.

For example, to support typical AIoT device identification values of 256 bits or 496 bits (or permanent AIoT device identifiers up to 356 bits or 596 bits) for applications requiring device identification larger than 96 bits or 128 bits (or permanent AIoT device identifiers up to 196 bits or 228 bits), such as in healthcare or global logistics, the paging ID length field may be configured to have a 10-bit (or 9-bit) value.

For another example, when an AIoT paging message has an AIoT device identification (paging ID) size of more than 8 bits (e.g., 10 bits or 9 bits), an additional paging ID size field can be included in the 8-bit paging ID size field to support forward compatibility of the paging message (e.g., including AIoT device identification (paging ID size−8) bits). For instance, if a 10-bit AIoT device identification/paging ID is supported in a future release/version (e.g., Rel-20), a 2-bit additional paging ID size field may be provided. This additional field can be included before the padding bits. For example, if the paging message used when CBRA is indicated to an AIoT device includes R2D Message Type, R2D length/transport block size, access type (e.g., CBRA), identification information associated with a single AIoT service request received from the core network (transaction ID), AIoT device identification (paging ID) and/or information indicating the presence of a paging ID length, paging ID length (8 bits), AIoT device identification (paging ID), number of access occasions, scheduling information for the subsequent D2R message/data for the R2D, instruction information for determining the monitoring window for the Random ID Response message (K: this field indicates that the value K is 1 (when set to 0) or 4 (when set to 1), used for determining the monitor window for Random ID Response message; the length of the field is 1 bit), and Fill bit (this field is of variable size and can be used to pad for byte alignment (1-7 bits)), then a paging message supporting a 10-bit AIoT device identification/paging ID may include: R2D Message Type, R2D length/transport block size, access type (e.g., CBRA), identification information associated with a single AIoT service request received from the core network (transaction ID), AIoT device identification (paging ID) and/or information indicating the presence of a paging ID length, paging ID length (8 bits), AIoT device identification (paging ID), number of access occasions, scheduling information for the subsequent D2R message/data for the R2D, instruction information for determining the monitoring window for the Random ID Response message (K), additional paging ID size (2 bits), additional paging ID, and Fill bit (this field is of variable size and can be used to pad for byte alignment (1-7 bits)).

Alternatively, when a paging message is used for an AIoT device to which CFA (Contention Free Access) is indicated, and the paging message includes R2D Message Type, R2D length/transport block size, access type (e.g., CFA), paging ID length, AIoT device identification (paging ID), scheduling information for the subsequent D2R message/data for the R2D, and Fill bit (This field is of variable size and can be used to pad for byte alignment (1-7 bits)), a paging message supporting a 10-bit AIoT device identification/paging ID may include: R2D Message Type, R2D length/transport block size, access type (e.g., CFA), paging ID length, AIoT device identification (paging ID), scheduling information for the subsequent D2R message/data for the R2D, additional paging ID size (2 bits), additional paging ID, and Fill bit (This field is of variable size and can be used to pad for byte alignment (1-7 bits)). An AIoT device supporting an 8-bit paging ID length field may ignore the additional paging ID size and additional paging ID fields. An AIoT device supporting a 10-bit paging ID length field can use the 8-bit paging ID length field together with the additional paging ID size bits to indicate a 10-bit paging ID size. An AIoT device supporting a 10-bit paging ID length field may include AIoT device identification using both the paging ID field and the additional paging ID field.

For another example, if the MAC header included in an R2D/D2R MAC PDU between an AIoT device and an AIoT RAN/reader includes information to support forward compatibility for the MAC PDU (e.g., protocol version, release, format type, service type version), such information can be prioritized/considered more important relative to other information included in the aforementioned MAC header.

For another example, specific information in the MAC header included in an R2D/D2R MAC PDU between an AIoT device and an AIoT RAN/reader for distinguishing the MAC PDU type (e.g., PDU-type/data type identification/Control-PDU-type, logical channel identification, AIoT message/service type information for the MAC PDU, overall/group/multiple/single device distinction, and/or information for indicating the reception success/failure of D2R messages/data/segments transmitted by the AIoT device) can be prioritized/considered more important relative to information for identifying the AIoT device, information for supporting efficient AIoT message/signaling/data transmission and reception, scheduling information, and/or information for indicating the presence of upper layer data/NAS messages/containers.

For another example, if specific information for identifying the AIoT device (e.g., information/field indicating the presence of AIoT device identification information, AIoT device identification information, information indicating the presence of an AS ID, AS ID, group device identification information, device identification information for multiple devices, and/or device identification information for a single device) is transmitted in cleartext, such information/fields may be prioritized/considered more important relative to information for supporting efficient AIoT message/signaling/data transmission and reception, scheduling information, and/or information indicating the presence of upper layer data/NAS messages/containers.

For another example, if specific information for identifying the AIoT device (e.g., information/field indicating the presence of AIoT device identification information, AIoT device identification information, information indicating the presence of an AS ID, AS ID, group device identification information, device identification information for multiple devices, and/or device identification information for a single device) is transmitted in encrypted form, such information/fields may be configured with lower priority/considered less important relative to information indicating the presence of upper layer data/NAS messages/containers.

For another example, if an AS ID is included, the AIoT device identification information may be omitted.

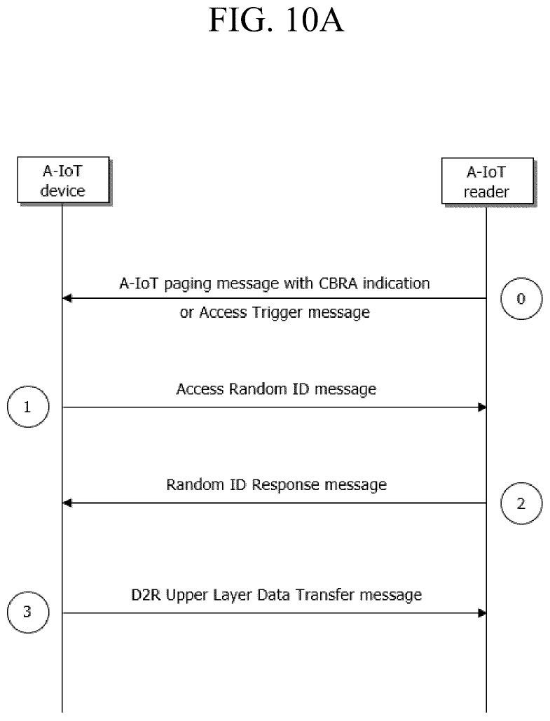

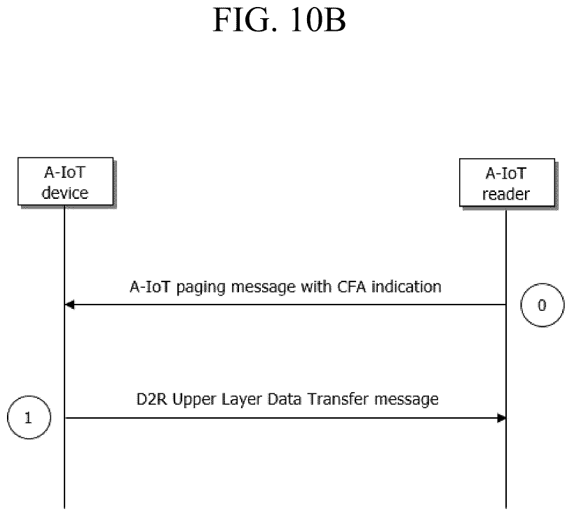

FIGS. 10A to 10B illustrate A-IoT access procedures to which one embodiment of the present specification may be applied.

The main services and functions of the A-IoT MAC layer are as follows:
Paging;
Access;
Transfer of upper layer data;
Construct MAC PDUs to be mapped onto D2R transport blocks and delivered to the physical layer;
MAC padding;
D2R segmentation;
Process MAC PDUs from R2D transport blocks delivered from the physical layer;
Failure detection.

### A-IoT Paging

A-IoT paging allows an A-IoT reader to trigger A-IoT CBRA or A-IoT CFA for one, multiple, or all A-IoT devices. The A-IoT paging message is transmitted on the PRDCH. An A-IoT paging message may include zero or one paging identifier. The paging identifier can be an A-IoT Device Permanent Identifier or filtering information. If the paging identifier is included, the paging message is transmitted to a specific A-IoT device or a group of A-IoT devices. If the paging identifier is not included, the paging message is transmitted to all A-IoT devices. Additionally, the A-IoT paging message provides configuration for the A-IoT access procedure.

### A-IoT Access Procedure

For A-IoT access, both an A-IoT contention-based random access (CBRA) procedure and an A-IoT contention-free access (CFA) procedure are supported. When an A-IoT device is paged, the A-IoT device initiates either the A-IoT CBRA procedure or the A-IoT CFA procedure according to an explicit instruction included in an A-IoT paging message.

In the case of CBRA (FIG. 10A), the A-IoT device randomly selects one access occasion among access occasions configured in the A-IoT paging message. In order to determine the start of the selected access occasion, the device may monitor an Access Trigger message, and transmits an A-IoT MSG1 (Access Random ID message) in the selected access occasion. The start of a first A-IoT MSG1 resource set is directly indicated by the A-IoT paging message instead of the Access Trigger message.

After transmitting the A-IoT MSG1, the device monitors an A-IoT MSG2 (Random ID Response message) until a configured number of Access Trigger messages or a subsequent A-IoT paging message is received. That is, any A-IoT MSG2 received thereafter is not processed.

When the A-IoT MSG2 includes a frequency index (if present) matching the frequency index used for the MSG1 transmission and includes the same Random ID as transmitted in the MSG1, the device considers that contention resolution is successful. Otherwise, the device considers that contention resolution has failed. When the contention resolution is successful, the device transmits a D2R Upper Layer Data Transfer message using resources provided in the A-IoT MSG2. When the contention resolution fails, if an A-IoT paging message having the same transaction ID is received, the device performs re-access.

In the case of CFA (FIG. 10B), the A-IoT device transmits the D2R Upper Layer Data Transfer message using a dedicated resource provided in the A-IoT paging message. In this case, monitoring of the Access Trigger message is not required.

According to an embodiment, the device in a wireless communication system transmits a first device to reader (D2R) medium access control (MAC) protocol data unit (PDU) including D2R upper layer data. In addition, after transmitting the first D2R MAC PDU, the device receives a first reader to device (R2D) MAC PDU including segment information. Thereafter, the device transmits a second D2R MAC PDU including a D2R upper layer data segment generated according to the segment information.

The device may receive a response message for contention-based random access, and the first D2R MAC PDU may be transmitted after receiving the response message.

Alternatively, the device may receive a paging message, and the first D2R MAC PDU may be transmitted after receiving the paging message. In this case, the paging message may include information indicating contention-free access.

Alternatively, the device may receive a second R2D MAC PDU, and the first D2R MAC PDU may be transmitted after receiving the second R2D MAC PDU.

Meanwhile, the segment information may be a data size indicating the last byte of original D2R upper layer data received by a reader. In this case, the D2R upper layer data segment may be generated starting from a byte immediately following the data size.

The first R2D MAC PDU may further include information indicating whether R2D upper layer data is included.

The embodiments described up to now may be implemented through various means. For example, the embodiments may be implemented by hardware, firmware, software, or a combination thereof. Details will be described with reference to the accompanying drawings.

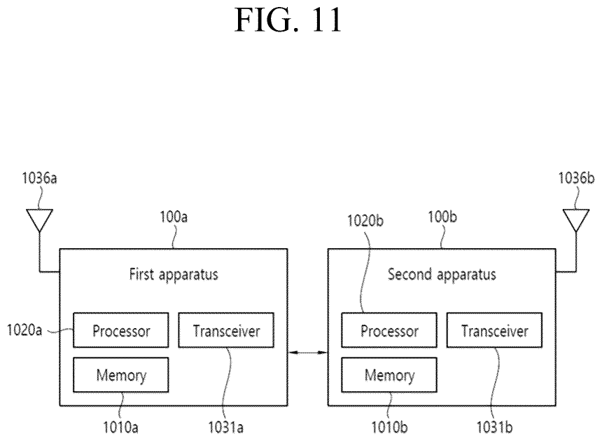

FIG. 11 is a block diagram showing apparatuses according to an embodiment of the disclosure.

Referring to FIG. 11, a wireless communication system may include a first apparatus 100a and a second apparatus 100b.

The first apparatus 100a may include a base station, a network node, a transmission terminal, a reception terminal, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medical apparatus, a finance technology (FinTech) apparatus (or a financial apparatus), a security apparatus, a climate/environment apparatus, an apparatus related to a 5G service, or other apparatuses related to the fourth industrial revolution.

The second apparatus 100b may include a base station, a network node, a transmission terminal, a reception terminal, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medical apparatus, a finance technology (FinTech) apparatus (or a financial apparatus), a security apparatus, a climate/environment apparatus, an apparatus related to a 5G service, or other apparatuses related to the fourth industrial revolution.

The first apparatus 100a may include at least one processor such as a processor 1020a, at least one memory such as a memory 1010a, and at least one transceiver such as a transceiver 1031a. The processor 1020a may be tasked with executing the previously mentioned functions, procedures, and/or methods. The processor 1020a may be capable of implementing one or more protocols. For example, the processor 1020a may perform and manage one or more layers of a radio interface protocol. The memory 1010a may be connected to the processor 1020a, and configured to store various types of information and/or instructions. The transceiver 1031a may be connected to the processor 1020a, and controlled to transceive radio signals.

The second apparatus 100b may include at least one processor such as a processor 1020b, at least one memory device such as a memory 1010b, and at least one transceiver such as a transceiver 1031b. The processor 1020b may be tasked with executing the previously mentioned functions, procedures, and/or methods. The processor 1020b may be capable of implementing one or more protocols. For example, the processor 1020b may manage one or more layers of a radio interface protocol. The memory 1010b may be connected to the processor 1020b and configured to store various types of information and/or instructions. The transceiver 1031b may be connected to the processor 1020b and controlled to transceive radio signaling.

The memory 1010a and/or the memory 1010b may be respectively connected inside or outside the processor 1020a and/or the processor 1020b and connected to other processors through various technologies such as wired or wireless connection.

The first apparatus 100a and/or the second apparatus 100b may have one or more antennas. For example, an antenna 1036a and/or an antenna 1036b may be configured to transceive a radio signal.

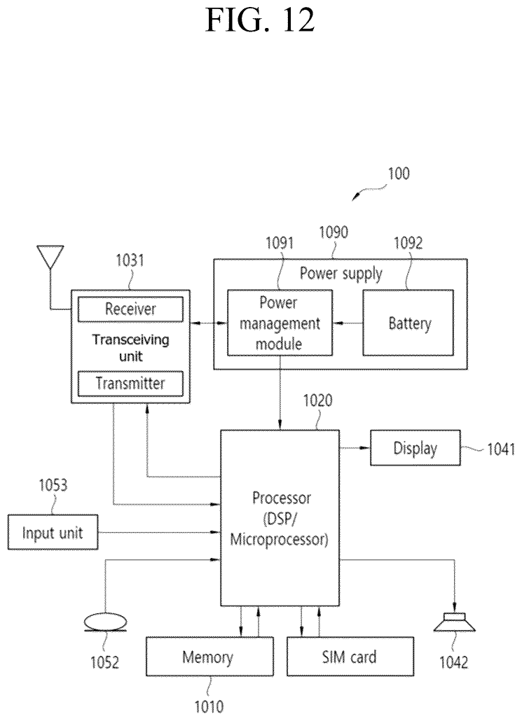

FIG. 12 is a block diagram showing a terminal according to an embodiment of the disclosure.

In particular, FIG. 12 illustrates the previously described apparatus of FIG. 11 in more detail.

The apparatus includes a memory 1010, a processor 1020, a transceiving unit 1031 (e.g., transceiving circuit), a power management module 1091 (e.g., power management circuit), a battery 1092, a display 1041, an input unit 1053 (e.g., input circuit), a loudspeaker 1042, a microphone 1052, a subscriber identification module (SIM) card, and one or more antennas. Some constituent elements are referred to as a unit in the disclosure. However, the embodiments are not limited thereto. For example, such term “unit” may also refer to as a circuit block, a circuit, or a circuit module.

The processor 1020 may be configured to implement the proposed functions, procedures, and/or methods described in the disclosure. The layers of the radio interface protocol may be implemented in the processor 1020. The processor 1020 may include an application-specific integrated circuit (ASIC), other chipsets, logic circuits, and/or data processing devices. The processor 1020 may be an application processor (AP). The processor 1020 may include at least one of a digital signal processor (DSP), a central processing unit (CPU), a graphics processing unit (GPU), and a modulator and demodulator (MODEM). For example, the processor 1020 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel®, KIRIN™ series of processors made by HiSilicon®, or the corresponding next-generation processors.

The power management module 1091 manages a power for the processor 1020 and/or the transceiver 1031. The battery 1092 supplies power to the power management module 1091. The display 1041 outputs the result processed by the processor 1020. The input unit 1053 may be an individual circuit that receives an input from a user or other devices and convey the received input with associated information to the processor 1020. However, the embodiments are not limited thereto. For example, the input unit 1053 may be implemented as at least one of touch keys or buttons to be displayed on the display 1041 when the display 1041 is capable of sensing touches, generating related signals according to the sensed touches, and transferring the signals to the processor 1020. The SIM card is an integrated circuit used to securely store international mobile subscriber identity (IMSI) used for identifying a subscriber in a mobile telephoning apparatus such as a mobile phone and a computer and the related key. Many types of contact address information may be stored in the SIM card.

The memory 1010 is coupled with the processor 1020 in a way to operate and stores various types of information to operate the processor 1020. The memory may include read-only memory (ROM), random access memory (RAM), flash memory, a memory card, a storage medium, and/or other storage device. The embodiments described in the disclosure may be implemented as software program or application. In this case, such software program or application may be stored in the memory 1010. In response to a predetermined event, the software program or application stored in the memory 1010 may be fetched and executed by the processor 1020 for performing the function and the method described in this disclosure. The memory may be implemented inside of the processor 1020. Alternatively, the memory 1010 may be implemented outside of the processor 1020 and may be connected to the processor 1020 in communicative connection through various means which is well-known in the art.

The transceiver 1031 is connected to the processor 1020, receives, and transmits a radio signal under control of the processor 1020. The transceiver 1031 includes a transmitter and a receiver. The transceiver 1031 may include a baseband circuit to process a radio frequency signal. The transceiver controls one or more antennas to transmit and/or receive a radio signal. In order to initiate a communication, the processor 1020 transfers command information to the transceiver 1031 to transmit a radio signal that configures a voice communication data. The antenna functions to transmit and receive a radio signal. When receiving a radio signal, the transceiver 1031 may transfer a signal to be processed by the processor 1020 and transform a signal in baseband. The processed signal may be transformed into audible or readable information output through the speaker 1042.

The speaker 1042 outputs a sound related result processed by the processor 1020. The microphone 1052 receives audio input to be used by the processor 1020.

A user inputs command information like a phone number by pushing (or touching) a button of the input unit 1053 or a voice activation using the microphone 1052. The processor 1020 processes to perform a proper function such as receiving the command information, calling a call number, and the like. An operational data on driving may be extracted from the SIM card or the memory 1010. Furthermore, the processor 1020 may display the command information or driving information on the display 1041 for a user's recognition or for convenience.

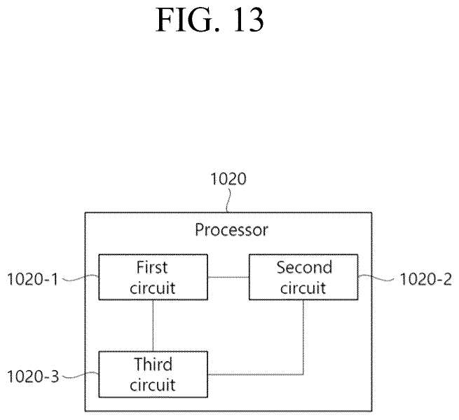

FIG. 13 is a block diagram of a processor in accordance with an embodiment.

Referring to FIG. 13, a processor 1020 may include a plurality of circuitry to implement the proposed functions, procedures, and/or methods described herein. For example, the processor 1020 may include a first circuit 1020-1, a second circuit 1020-2, and a third circuit 1020-3. Also, although not shown, the processor 1020 may include more circuits. Each circuit may include a plurality of transistors.

The processor 1020 may be referred to as an application-specific integrated circuit (ASIC) or an application processor (AP) and may include at least one of a digital signal processor (DSP), a central processing unit (CPU), and a graphics processing unit (GPU).

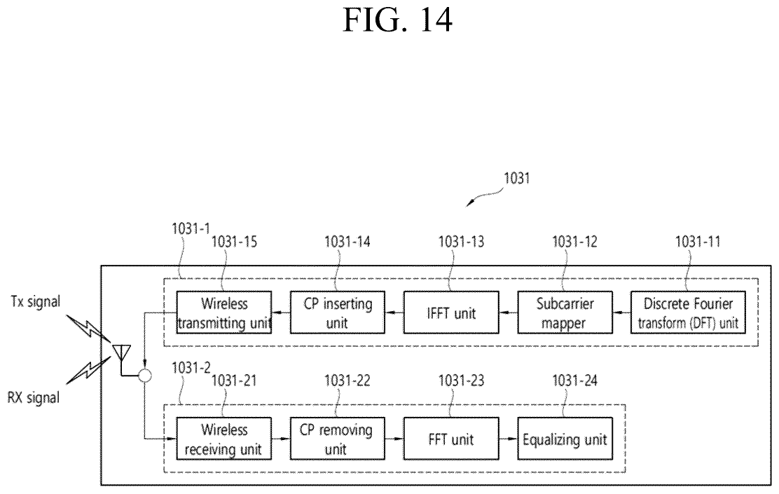

FIG. 14 is a detailed block diagram of a transceiver of a first apparatus shown in FIG. 11 or a transceiving unit of an apparatus shown in FIG. 12.

Referring to FIG. 14, the transceiving unit 1031 (e.g., transceiving circuit) includes a transmitter 1031-1 and a receiver 1031-2. The transmitter 1031-1 includes a discrete Fourier transform (DFT) unit 1031-11 (e.g., DFT circuit), a subcarrier mapper 1031-12 (e.g., subcarrier mapping circuit), an IFFT unit 1031-13 (e.g., IFFT circuit), a cyclic prefix (CP) insertion unit 1031-14 (e.g., CP insertion circuit), and a wireless transmitting unit 1031-15 (e.g., wireless transmitting circuit). The transmitter 1031-1 may further include a modulator. Further, the transmitter 1031-1 may for example include a scramble unit (e.g., scrambling circuit), a modulation mapper, a layer mapper, and a layer permutator, which may be disposed before the DFT unit 1031-11. That is, to prevent a peak-to-average power ratio (PAPR) from increasing, the transmitter 1031-1 subjects information to the DFT unit 1031-11 before mapping a signal to a subcarrier. The signal spread (or pre-coded) by the DFT unit 1031-11 is mapped onto a subcarrier by the subcarrier mapper 1031-12 and made into a signal on the time axis through the IFFT unit 1031-13. Some constituent elements are referred to as a unit in the disclosure. However, the embodiments are not limited thereto. For example, such term “unit” may also refer to a circuit block, a circuit, or a circuit module.

The DFT unit 1031-11 performs DFT on input symbols to output complex-valued symbols. For example, when Ntx symbols are input (here, Ntx is a natural number), DFT has a size of Ntx. The DFT unit 1031-11 may be referred to as a transform precoder. The subcarrier mapper 1031-12 maps the complex-valued symbols onto respective subcarriers in the frequency domain. The complex-valued symbols may be mapped onto resource elements corresponding to resource blocks allocated for data transmission. The subcarrier mapper 1031-12 may be referred to as a resource element mapper. The IFFT unit 1031-13 performs IFFT on the input symbols to output a baseband signal for data as a signal in the time domain. The CP inserting unit 1031-14 copies latter part of the baseband signal for data and inserts the latter part in front of the baseband signal for data. CP insertion prevents inter-symbol interference (ISI) and inter-carrier interference (ICI), thereby maintaining orthogonality even in a multipath channel.

On the other hand, the receiver 1031-2 includes a wireless receiving unit 1031-21 (e.g., wireless receiving circuit), a CP removing unit 1031-22 (e.g., CP removing circuit), an FFT unit 1031-23 (e.g., FFT circuit), and an equalizing unit 1031-24 (e.g., equalizing circuit). The wireless receiving unit 1031-21, the CP removing unit 1031-22, and the FFT unit 1031-23 of the receiver 1031-2 perform reverse functions of the wireless transmitting unit 1031-15, the CP inserting unit 1031-14, and the IFFT unit 1031-13 of the transmitter 1031-1. The receiver 1031-2 may further include a demodulator.

According to the embodiments of the disclosure, data communication of a device that provides ultra-low complexity and ultra-low power operation in a wireless communication system may be effectively controlled.

Although the preferred embodiments of the disclosure have been illustratively described, the scope of the disclosure is not limited to only the specific embodiments, and the disclosure can be modified, changed, or improved in various forms within the spirit of the disclosure and within a category written in the claim.

In the above exemplary systems, although the methods have been described in the form of a series of steps or blocks, the disclosure is not limited to the sequence of the steps, and some of the steps may be performed in different order from other or may be performed simultaneously with other steps. Further, those skilled in the art will understand that the steps shown in the flowcharts are not exclusive and may include other steps or one or more steps of the flowcharts may be deleted without affecting the scope of the disclosure.

Claims of the present disclosure may be combined in various manners. For example, technical features of the method claim of the present disclosure may be combined to implement a device, and technical features of the device claim of the present disclosure may be combined to implement a method. In addition, the technical features of the method claim and the technical features of the device claim of the present disclosure may be combined to implement a device, and technical features of the method claim and the technical features of the device claim of the present disclosure may be combined to implement a method.

What is claimed is:

1. A method for processing data of a device in a wireless communication system, the method comprising:
transmitting a first device to reader (D2R) medium access control (MAC) protocol data unit (PDU) including D2R upper layer data;
after transmitting the first D2R MAC PDU, receiving a first reader to device (R2D) MAC PDU including segment information; and
transmitting a second D2R MAC PDU including a D2R upper layer data segment generated according to the segment information.

2. The method of claim 1, further comprising:
receiving a response message for contention-based random access,
wherein the first D2R MAC PDU is transmitted after receiving the response message.

3. The method of claim 1, further comprising:
receiving a paging message,
wherein the first D2R MAC PDU is transmitted after receiving the paging message.

4. The method of claim 1, further comprising:
receiving a second R2D MAC PDU,
wherein the first D2R MAC PDU is transmitted after receiving the second R2D MAC PDU.

5. The method of claim 3, wherein the paging message includes information indicating contention-free access.

6. The method of claim 1, wherein the segment information is a data size indicating a last byte of original D2R upper layer data received by a reader.

7. The method of claim 1, wherein the first R2D MAC PDU further includes information indicating whether R2D upper layer data is included.

8. The method of claim 6, wherein the D2R upper layer data segment is generated starting from a byte immediately following the data size.

9. A device in a wireless communication system, comprising:
at least one processor; and
at least one memory configured to store instructions and operably electrically connectable to the at least one processor,
wherein operations performed based on the instructions executed by the at least one processor comprise:
transmitting a first device to reader (D2R) medium access control (MAC) protocol data unit (PDU) including D2R upper layer data;
after transmitting the first D2R MAC PDU, receiving a first reader to device (R2D) MAC PDU including segment information; and
transmitting a second D2R MAC PDU including a D2R upper layer data segment generated based on the segment information.

10. The device of claim 9, wherein operations performed based on the instructions executed by the at least one processor further comprise:
receiving a response message for contention-based random access,
wherein the first D2R MAC PDU is transmitted after receiving the response message.

11. The device of claim 9, wherein operations performed based on the instructions executed by the at least one processor further comprise:
receiving a paging message,
wherein the first D2R MAC PDU is transmitted after receiving the paging message.

12. The device of claim 9, wherein operations performed based on the instructions executed by the at least one processor further comprise:
receiving a second R2D MAC PDU,
wherein the first D2R MAC PDU is transmitted after receiving the second R2D MAC PDU.

13. The device of claim 11, wherein the paging message includes information indicating contention-free access.

14. The device of claim 9, wherein the segment information is a data size indicating a last byte of original D2R upper layer data received by a reader.

15. The device of claim 9, wherein the first R2D MAC PDU further includes information indicating whether R2D upper layer data is included.

16. The device of claim 14, wherein the D2R upper layer data segment is generated starting from a byte immediately following the data size.
